(19) United States
(12) Patent Application Publication
(10) Pub. No.: US 2005/0013759 A1
(43) Pub. Date: Jan. 20, 2005

(54) Practical method for preparing inorganic nanophase materials

(76) Inventor: Ann E. Grow, San Diego, CA (US)

Correspondence Address: Cathryn Campbell;McDERMOTT WILL & EMERY LLP, Suite 700, 4370 La Jolla Village Drive, San Diego, CA, 92122, US

(21) Appl. No.: 10/864,659

(22) Filed: Jun. 8, 2004

Related U.S. Application Data
(63) Continuation of application No. 09/527,371, filed on Mar. 16, 2000, now abandoned.
Application No. 09/527,371 is a continuation of application No. 08/904,702, filed on Aug. 1, 1997, now abandoned.
(60) Provisional application No. 60/024,375, filed on Aug. 14, 1996.

(51) Int. Cl. C01G 56/00; C01F 17/00; C01B 25/00

(52) U.S. Cl. 423/263; 423/251; 423/592.1; 423/299; 423/326; 423/419.1; 423/659; 423/544; 423/561.1

(57) ABSTRACT

A simple, practical, inexpensive process for producing novel inorganic catalysts, nanocatalysts, and other nanophase materials possessing unique chemical and physical properties is described. A microbial reagent is incubated in a liquid medium to synthesize an extracellular precipitate. This extracellular precipitate may then be further processed by any of a variety of techniques to alter or improve its chemical and physical properties. The various factors that can affect and control the properties of the nanophase materials, such as the selection and preparation of the microbial reagent, the nature of the incubation conditions, and the utilization of post-incubation treatments, and the types of nanophase materials that can be prepared by this invention, are described.

### RELATED APPLICATIONS

This application replaces Provisional Application 60/024,375 filed on Aug. 14, 1996.

### FIELD OF THE INVENTION

The present invention relates to the simple, inexpensive preparation of novel inorganic catalysts, nanocatalysts, and other nanophase materials possessing unique chemical and physical properties, suitable for applications such as treatment of organic pollutants, chemical and fuel processing, and reducing hazardous emissions; fabrication of arrays of particles for use in devices based on quantum confinement; consolidation into nanostructured metals, intermetallics, ceramics, and cermets, optics and electronics; production of superparamagnetic materials for magnetic refrigeration, semiconductor, and photocatalytic materials; and the like. More particularly, this invention relates to the preparation and use of a microbial reagent to synthesize an extracellular nanophase inorganic precipitate.

### BACKGROUND OF THE INVENTION

There are many and highly diverse applications for catalysts, ranging from synthesis of pharmaceuticals and hydrogenation of heavy oil “resids”, to remediation of environmental pollution and reduction of hazardous vehicle emissions, to service as proton exchange membrane fuel cell anodes. Accordingly, catalysts have been developed in forms as disparate as microbial cells, enzyme macromolecules, complex inorganic zeolites, fullerene carbons, and carbogenic molecular sieves (CMSs), and fine metal powders.

There has been considerable recent interest in the design and use of biocatalysts, i.e., catalytic organic materials produced by living organisms ranging from “natural” biological macromolecules such as enzymes, to chemically-modified “natural” biological molecules such as abzymes, to genetically engineered cell products. A recent review (J G Tirrell, M J Fournier, T L Mason, and D A Tirrell, Biomolecular Materials, Chemical and Engineering News, Dec. 19, 1994, pages 40-51) catalogued the, applications under consideration for biocatalysis. Virtually without exception, the biocatalysts that are being produced through the use of microorganisms are biochemicals. In the vast majority of cases, these biocatalysts are of interest because of their ability to catalyze highly specific, and often highly unusual reactions. Some of these biocatalysts are utilized while still residing within the microorganism that biosynthesized them; others are separated from the microbes and purified, and used in solution or suspension or as immobilized preparations.

Inorganic metal catalysts are at the other extreme of the catalyst spectrum, in that they are of relatively simple chemical structure, tend to be more nonspecific in the reactions that they catalyze, and are usually produced by conventional processes such as chemical precipitation, crystal growth, electrolytic, and liquid metal processing techniques. Transition metals in particular are well known to be capable of catalyzing a remarkable array of reactions. The massive international catalyst industry is based in large part on catalysts comprised of transition metal complexes and powders, and solid supports doped with transition metal ions and clusters. However, while metal-based reagents can be highly-effective catalysts, they have not proven to be practical or economical for many applications due to the cost of their preparation.

Nanophase materials are usually defined as having some length scale smaller than 100 nm in at least one dimension. An important subset of nanophase materials is powders with particle size less than 100 nm, including polycrystalline materials made by consolidating these powders in such a way as to retain a grain size below this limit. They are of increasing considerable interest for an extremely wide variety of applications, due to the unusual nature and properties of materials produced in this size range. The choice of 100 nm stems from the fact that,many physical, optical, and magnetic properties have characteristic lengths in this range. As grain or particle size is reduced below this characteristic length, the properties associated with these phenomena are radically altered. A frequently cited example is the freezing out of mechanisms for generating glissile dislocations.

One of most important applications for nanophase inorganic materials is their use as catalysts and destructive adsorbents. (Nanophase catalysts and nanophase destructive adsorbents are hereinafter collectively referred to as ‘nanocatalysts.’). Nanocatalysts often demonstrate chemical properties that differ dramatically from those of conventional inorganic catalysts. Studies have repeatedly shown that nanocatalysts exhibit unique reaction phenomena because they possess extremely large surface areas; the higher the surface area, the more rapid the kinetics and the more unusual and diverse the reactions that are catalyzed. The mechanisms whereby nanocatalysts achieve their remarkable adsorptive and reactive properties are not well-understood, but appear to be the result of unique surface chemistries, defect structures, grain boundary structures, and surface phonons. In addition, the very high proportion of metal atoms at, or near, grain boundaries in nanophase materials (>=50% for grain sizes below 5-10 nm) leads to very rapid substrate diffusion coupled with very short diffusion distances. Conventional catalysts can be expensive, due to the need to utilize rare or precious metals such as platinum, palladium, vanadium, ruthenium, and zirconium. With nanophase production techniques, however, it is possible to utilize low-cost, common metals such as iron instead. For example, since the catalyst is destroyed during coal liquefaction, an inexpensive, disposable material is required. This requirement effectively limits the choices to catalysts comprised, for example, of iron, iron oxides, or iron sulfides. Colloidal Fe and Mn oxides have been shown to react with many different organics. Preliminary studies have recently demonstrated that although bulk iron sulfides are noncatalytic, a nanophase FeS₂ pyrite significantly increased the yield of heptane soluable sols from coal powder. It is also known that nanophase Fe₂O₃/MgO prepared by aerogel/hypercritical drying is effective at elevated temperatures for the broad-spectrum treatment of hazardous organics, including phosphorus, nitrogen, sulfur, and halogen containing chemicals (K J Klabunde et al, in Nanophase Materials: Synthesis Properties Applications, G C Hadjipanayis and R W Siegel, eds, Kluwer Academic Publishers, Dordrecht, The Netherlands, pages 1-23, 1994).

Intense research on the properties and potential uses of nanophase materials has led to the development of a wide variety of methods for the production of nanophase materials such as nanocatalysts. Nanophase material production methods typically involve metal evaporation and subsequent deposition (dc and rf magnetron sputtering and reactive sublimation, molecular beam epitaxy, nanolithography,,cluster formation in atomic or molecular beams); processing of bulk precursors (mechanical attrition, crystallization from the amorphous state, phase separation); and sophisticated, complex chemical techniques such as inverse micelle aerogel precipitation/hypercritical drying, sonochemical decomposition of organometallic precursors, exfoliation, and ‘pillaring’ of natural clays and layered metal phosphates. Nevertheless, commercialization of nanophase materials such as nanocatalysts has been very slow. One of the key reasons is that the methods available for the manufacture of nanophase materials are low-yield, energy intensive, difficult to scale up, often produce high levels of hazardous wastes, and may require the use of costly organometallic precursors. Such nanophase material production methods yield catalysts which are extremely efficient, but still extremely expensive. Further, a nanophase production method that can be used to produce one chemical category of nanophase materials generally cannot be used to produce many other types of nanophase materials.

Recently, biochemists have become involved in synthesizing and studying nanophase materials. It is known that many microbial processes result in metal precipitation, both intracellularly and extracellularly. Such ‘biomineralization’ processes are usually divided into those that are biologically-controlled (i.e., metal precipitates form within cells as a result of interactions between metal ions and specific enzymes or biomolecular matrices) and those that are biologically-induced [i.e., metal precipitates form external to the cells, whether as a result of metabolism changing the environmental conditions (e.g., changing the pH) or producing a reactive extracellular product (e.g., H₂S or H₂O₂), metal binding to a specific cell surface component, or direct microbial catalysis of a redox reaction]. Since intracellular biomineralization is under the control of intricate biological systems, it is believed to have the potential of leading to materials with unusual and/or particularly desirable characteristics. The classic example is the formation of magnetite within the magnetosomes of magnetotactic bacteria, which has come under study for nanophase material applications (D P E Dickson, in Nanophase Materials: Synthesis Properties Applications, G C Hadjipanayis and R W Siegel, eds, Kluwer Academic Publishers, Dordrecht, The Netherlands, p 729, 1994). The magnetite formed by such processes is coated with a biomolecular membrane, which complicates the production of useful nanophase products and limits the number of potential applications. At the biomolecular level, a recent series of elegant studies has shown that the protein cages of the naturally occurring iron-storage and -transport proteins known as ferritins can be emptied of their natural cores and used as reaction vessels in which manganese, uranium, and ferrimagnetic iron oxides can be formed (T G St Pierre et al, in Nanophase Materials: Synthesis Properties Applications, G C Hadjipanayis and R W Siegel, eds, Kluwer Academic Publishers, Dordrecht, The Netherlands, p 49, 1994). Unfortunately, only a handful of biologically-controlled metal precipitation processes are known; and precisely because their processes are tightly controlled, their products [symbol] and, hence, their potential applications in the synthesis of nanophase materials [symbol] are severely limited.

Biologically-induced metal precipitation, on the other hand, takes place via many different biotic and abiotic mechanisms, and has been associated with the formation of many different minerals, including oxides, hydroxides, and oxyhydroxides, sulfides, phosphates, carbonates, sulfates, silicates, and elemental materials, among others. While oxidation, reduction, and precipitation of metals in the environment have been recognized as microbially-mediated reactions since the beginning of this century, remarkably little is known about the mechanisms involved, and even less is known about the precipitates that are formed (C R Myers and K H Nealson, in Transport and Transformation of Contaminants Near the Sediment-Water Interface, J V DePinto, W Lick and J F Paul, eds, 205-224, CRC Press, Inc., Boca Raton, FlA., 1994). Attention has been focused almost exclusively on the binding of inorganic ions to biological macromolecules and the mechanisms of various oxidation/reduction (redox) transformations. Once the inorganic ion has undergone redox transformation, it is no longer of any interest, whether it is released into solution as an ion or forms a precipitate. Since the precipitation itself takes place in the external environment, extracellular inorganic precipitates are assumed to be formed outside the control of the organism and therefore formed via well-established and well-understood wet-chemistry processes; and biologically-induced metal precipitation mechanisms are therefore assumed to yield conventional minerals with conventional properties. When mentioned at all, extracellular precipitates are casually dismissed as “typically [having] no unique morphology” (B M Tebo, in Genetic Engineering, vol 17, J K Setlow, ed, Plenum Press, New York, 1995).

The fact that microorganisms can precipitate large quantities of many different organics is very well established, and has been studied for a number of reasons. For example, the so-called “iron bacteria” are capable of forming such massive quantities of extracellular ferromanganates that they are a major nuisance due to the role they play in the clogging of pipelines. On the more positive side, the ability of microorganisms to take up large quantities of heavy metals extracellularly has come under scrutiny for potential applications in the treatment of heavy metal and radionuclide pollution. The impact of microbe/metal interactions can be of even more importance ecologically; it has become reasonably well-established that microbes control the cycling of heavy metals and radionuclides throughout the environment.

Very recently, preliminary studies have indicated that the extracellular precipitation of manganese oxides may even play a role in the oxidation of organics, a process long thought to be under the exclusive control of biotic processes. It should be noted, however, that the studies on this last topic have focused on the impact that the organics have on the metal oxides. As a recent survey noted, “Detailed studies of abiotic electron-transfer reactions in a geochemical context have focused primarily on the reductive dissolution of metal oxides by natural and contaminant reductants” (W Fish, in Metals in Groundwater, H E Allen, E M Perdue, and D S Brown, eds., Lewis Publishers, Chelsea, MI, 73-101, 1993). Virtually without exception, the precipitates used in studies to evaluate the potential ecological impact of microbially-produced extracellular inorganic precipitate interactions with organics have been synthesized by conventional chemical precipitation techniques, not by microorganisms themselves, underlining and emphasizing the common assumption that the extracellular precipitates produced by microorganisms are precisely the same as the precipitates produced by conventional chemical precipitation techniques (see, for example, L Ukrainczyk and M B McBride, Clays and Clay Minerals 40(2), 157-166, 1992; M B McBride, Soil Sci Soc Am J 51, 1466-1472, 1472, 1987; R-A Doong and S-C Wu, Chemosphere 24 (8), 1063-1075, 1992; and F M Dunnivant, R P Schwarzenbach, and D L Macalady, Envir Sci Tech 26(N11), 2133-2141, 1992). It has been assumed that since the inorganic precipitates are formed outside the cell, they are not in a biologically-controlled environment as they would be if they were to form intracellularly; and that extracellular microbial precipitation processes, mechanisms, and phenomena are therefore exactly the same as conventional chemical precipitation processes and produce exactly the same precipitates with exactly the same properties as chemical precipitation performed under very mild conditions. The synthetic ferromanganese materials used in these studies were shown to be somewhat reactive against a number of organic pollutants; studies performed with synthetic iron sulfides, however, concluded that iron sulfide precipitates react very slowly, if at all, with organics such as volatile chlorinated hydrocarbons and nitroaromatics. The researchers therefore concluded unanimously that mechanisms other than microbial formation of extracellular inorganic precipitates must be involved in the environmental transformation of organics.

Despite the significant economical and ecological impact of microorganisms that deposit metal precipitates extracellularly, virtually nothing is known about the nature of the inorganic precipitates themselves. Microbial extracellular precipitation of inorganic materials is often referred to as ‘biomineralization’; with aging and dehydration, conventional inorganic precipitates can be transformed into minerals, and since microbial inorganic precipitates are therefore considered to be the forerunners of, or identical with, minerals, the microbially-produced precipitates themselves are usually referred to as ‘minerals’, i.e., no distinction is made between the two. Most researchers studying ‘biomineralization’ phenomena have been satisfied with determining whether a given inorganic species has been oxidized or reduced in the process of metal or metalloid deposition. A handful have gone as far as analyzing the elements in the inorganic precipitate and determining their relative proportions, and have then assigned the name of a common mineral that is comprised of such a ratio to the precipitate. One or two have gone to the extreme of “confirming” the “identity” of the precipitates by testing their solubility in mild acid. None have investigated any other chemical or physical properties, nor has there been any indication that the structure or chemistry of the precipitate itself might even be of interest. For example, the extracellular metal precipitate that has garnered by far the most interest is found in the “stalks” of the iron bacteria Gallionella. However, while there has been an intense debate over the nature of these stalks, the studies [symbol] and arguments [symbol] have been over whether the stalks contain any living mycoplasmoid organism rather than over the structure or properties of the iron precipitate itself (W C Ghiorse, Ann Rev Microbiol 38, 515-550, 1984). The metal itself is dismissed as being “amorphous ferric hydroxide”, and the only diffraction and NMR spectroscopy studies that were performed were analyzed with regard to how and where the iron hydroxide binds to the filaments, rather than to determine the chemistry and properties of the ferric hydroxide itself.

Freke and Tate (Journal of Biochemical and Microbiological Technology and Engineering, 3(1), 29-39, 1961) generated a brief spurt of interest when they reported that a mixed culture containing sulfate reducing bacteria (SRBs) had produced an iron sulfide that was susceptible to a magnetic field. However, they were unable to determine the conditions under which the magnetic material was formed; and their analysis of the material itself was very scanty. They determined the moisture content as being approximately 80%, and the density as being 2.9. While they noted that the observed density was lower than the known values for sulfides of iron, they argued that their analysis may have been faulty rather than that the material may have possessed unusual properties. An empirical formula of Fe₄S₅ was established, which they noted did not match either formula that had been established for known magnetic iron sulfides; although again, they did not pursue the apparently unusual nature of the precipitate any further. All interest quickly died out as other researchers were unable to reproduce the reported magnetic material (R O Hallberg, Antonie van Leeuwenhoek 36, 241, 1970). Other mention of the structure or composition of extracellular metal precipitates is essentially anecdotal. For example, a large amount of “acanthite (Ag₂S)” was reported to have precipitated on the cells' surface when the bacterium Thiobacillus ferrooxidans was grown in the presence of a sulfide ore (F D Pooley, Nature 296, 693, 1982). Wood and Wang (Environ Sci Technol 17, 582A, 1983) described the precipitation of dendritic crystals of nickel sulfides at algal cell surfaces; but never characterized these crystals. A few other researchers have occasionally mentioned the formation of “amorphous” precipitates. None of the researchers has gone any farther toward characterizing the “amorphous” precipitates themselves, or even the more structured fibrils noted with the nickel sulfide dendritic crystals on the algal cell surfaces, or the iron hydroxide deposits on the Gallionella stalks. In a survey of modern analytical chemistry as it is used in the study of microbial/metal interactions, Brinckman and Olson (Biotechnology and Bioengineering Symp No 16, John Wiley & Sons, Inc., New York, pages 35-44, 1986) enthusiastically detailed the methods used to study metal-specific ligands that serve as active metal coordination sites on cell envelopes, but acknowledged, without any indication of regret or censure, that the “micromorphology” of even the structured metal precipitates that had been reported had never been characterized.

Certainly, no one has questioned whether the precipitates might have any unusual properties aside from the rare occurrence of a precipitate that was reported to be susceptibility to a magnetic field. Even researchers such as Freke and Tate, who determined that more than one “mineral” can be formed, did not think to seriously question why one “mineral” might be formed in favor of another or study the phenomena that control the formation of a given precipitate. It is apparent that the other researchers who study microbe/metal interactions have assumed that once biotic processes such as manganese reduction or sulfide formation and excretion are completed, the remaining processes involved in extracellular formation of metal precipitates are simply a matter of conventional inorganic chemistry principals, and result in conventional inorganic precipitates.

### BRIEF DESCRIPTION OF THE INVENTION

It is an object of the present invention to provide a novel means for preparing inorganic catalysts, nanocatalysts, and other nanophase inorganic materials.

It is also an object of the present invention to provide a simple, efficient, inexpensive process for nanophase material production under ambient conditions.

It is also an object of the present invention to provide a means for producing novel and unique inorganic materials, especially nanophase and nanocatalyst materials, that possess unusual and desirable properties.

The present invention comprises two or more steps. In the first step, a suitable microorganism or mixture of microorganisms is selected and readied for use (i.e., the ‘microbial reagent’ is prepared). This step may or may not include special treatments of the microorganism or microbial mixture to produce a microbial derivative, as will be discussed below. In the second step, the microbial reagent is incubated in a medium containing suitable constituents in suitable proportions. The second step may involve control or adjustment of environmental conditions (including, but not necessarily limited to, temperature, pressure, pH, dissolved gases, light, and the like), during the formation of the precipitates to cause production of nanophase materials with the desired characteristics. Any subsequent steps, which may or may not be desired, consist of subjecting the precipitate to one or more of a series of suitable post-treatments, which may include, but are not necessarily limited to, further incubations with the same microbial reagent and/or different microbial reagents in suitable media, incubation in chemical solutions, drying, treating with gases, heating, separation of the nanophase material from the microbial cell, and the like. The inorganic catalysts, nanocatalysts, and other nanophase materials that can be produced and used in accordance with the present invention include, but are not limited to, for example, oxides, hydroxides, and oxyhydroxides [hereinafter collectively referred to as ‘(hydr)oxides’], sulfides, phosphates, sulfates, carbonates, silicates, elemental metals and metalloids, and mixtures thereof, and the like.

It will be apparent from the following detailed description of the present invention, which is intended to be illustrative thereof rather than taken in a limiting sense, that a much improved process to produce inorganic catalysts, nanocatalysts, and other nanophase materials is provided which offers a great deal of versatility and significant advantages over prior art methods.

### BRIEF DESCRIPTION OF THE FIGURES

FIGS. 1-3 present descriptions of some of the manganese oxide nanophase materials, including a number of manganese oxide nanocatalysts, that may be produced in accordance with the present invention by incubating a single microbial reagent (in this case, a marine Bacillus spore) in a variety of dilute aqueous media under a range of incubation conditions; and

FIG. 4 presents descriptions of some of the iron sulfide nanophase materials, including a number of iron sulfide nanocatalysts, that may be produced in accordance with the present invention by incubating a single microbial reagent (in this case, a salt-tolerant Desulfovibrio) in a variety of dilute aqueous media under a range of incubation conditions.

### DETAILED DESCRIPTION OF THE PREFERRED EMBODIMENTS

In general, the present invention involves the use of microorganisms to produce a wide variety of desirable, novel, and/or unique inorganic materials through the microbially-mediated formation of extracellular precipitates.

It is known that microorganisms can produce inorganic precipitates of interesting and unusual properties within the cells and, more specifically, within biological macromolecules or macromolecule complexes such as protein cages or within organelles such as magnetosomes. There are only a few such microbially-controlled, intracellular inorganic precipitation processes, and the number of nanophase materials that can be prepared thereby is limited.

It is also known that microorganisms induce the formation of extracellular inorganic precipitates such as metal precipitates. Because microorganisms can interact with inorganic ions through a variety of different phenomena to cause the precipitation of metals, metalloids, and other inorganics, a wide variety of different inorganic precipitates can be formed extracellularly, including, for example, oxides, hydroxides, sulfides, phosphates, sulfates, carbonates, silicates, elemental metals and metalloids, and mixtures thereof. Although it is well established that microorganisms are often involved in the formation of such inorganic precipitates in the environment, it has been assumed that precipitation processes that occur outside the cell (i.e., extracellular reactions) are outside the control or influence of the microorganism, and that extracellular precipitation processes are therefore the same as conventional chemical precipitation processes. It has therefore been assumed that these extracellular precipitation processes yield the same materials as prior art chemical precipitation processes do. Therefore, it has also been tacitly assumed that there are no advantages to the use or participation of microorganisms in the extracellular production of inorganic precipitates.

It has now been shown that the materials that form during microbial extracellular precipitation processes are, in fact, novel, unusual, and/or desirable nanophase materials. It has also now been shown that the production of select nanophase precipitates with desired properties can be controlled through the use of simple mechanisms such as the choice of the appropriate microorganism, the proper preparation of that microorganism to serve as a microbial reagent in accordance with the present invention, the proper incubation medium and conditions, and, if desired, the use of simple post-treatments. Therefore, the present invention enables the formation of novel, unusual, and/or desirable inorganic nanophase materials, produced simply and inexpensively, under relatively mild conditions, with inexpensive reagents.

Broad Description of the Invention

In general, the present invention comprises two or more steps, i.e., 1) selection of the microorganism or mixture of microorganisms to be used, and any special treatments to be used to prepare the microbial reagent; 2) incubation of the microbial reagent in a liquid medium to produce an extracellular precipitate; and, if desired, 3) one or more of a series of post-treatments to the extracellular precipitate that the microbial reagent has produced.

The basic principal underlying the present invention is that microorganisms, through their ability to control and influence the microenvironments immediately surrounding the cell as well as inside the cell, can create conditions in the extracellular microenvironment that cannot readily be reproduced by prior art wet chemistry techniques, if at all; and that these microbially-controlled and -influenced microenvironments foster the formation of desirable, novel, and/or unique inorganic precipitates.

It has now been shown that the metal-containing precipitates formed extracellularly by microorganisms in accordance with the present invention can be novel materials with unique chemical and physical properties, i.e., that the chemical and physical properties of extracellular inorganic precipitates differ from those of inorganic precipitates formed by conventional chemical precipitation or nanophase material synthesis routes. Further, it has now been found that many of these unique, microbially-produced precipitates are nanophase materials possessing unusual and/or desirable properties, e.g., catalytic, optical, structural, and/or magnetic properties. Due to their unusual properties, these microbially-formed extracellular inorganic precipitates can be excellent catalysts, nanocatalysts, and nanophase materials suitable for a wide range of applications.

Advantages Over the Prior Art

One of the most important properties of the inorganic catalysts or nanocatalysts produced in accordance with the present invention is their surface areas. It has now been found that microbially-formed extracellular precipitates can have surface areas that are far higher than inorganic nanophase materials produced by any prior art technique, including those nanophase production techniques discussed earlier. For example, nanophase materials produced by prior art techniques range in surface area from 10-30 m²/g for Fe—Co alloys (K S Suslick, M Fang, T Hyeon, and A A Cichowlas, in Molecularly Designed Ultrafine/Nanostructured Materials, K E Gonsalves, G-M Chow; T D Xiao, and R C Cammarata eds, p 443, Materials Research Society, Pittsburgh, Pa., 1994) to 80-120 m²/g for metal oxides (Y S Zhen, K E Hrdina, and R J Remick, in Molecularly Designed Ultrafine/Nanostructured Materials, K E Gonsalves, G-M Chow, T D Xiao, and R C Cammarata eds, p 425, Materials Research Society, Pittsburgh, Pa., 1994) to the “very high” surface area of 188 m²/g for a molybdenum carbide (K S Suslick, T Ryeon, M Fang, and A A Cichowlas, in Molecularly Designed Ultrafine/Nanostructured Materials, K E Gonsalves, G-X Chow, T D Xiao, and R C Cammarata eds, p 201, Materials Research Society, Pittsburgh, Pa., 1994). By comparison, the present invention can be used to produce inorganic materials with extraordinarily high surface areas. For example, whereas iron sulfides produced by conventional chemical precipitation techniques generally possess surface areas of <5-10 m²/g, a nanophase iron sulfide produced in accordance with this invention had a surface area exceeding 2,000 m²/g. It has further been shown that the unusual inorganic materials produced in accordance with the present invention may be highly reactive. For example, whereas conventional iron sulfides are considered to be nonreactive, an ultra-high-surface-area nanophase iron sulfide produced in accordance with this invention has been shown to be capable of rapidly adsorbing and degrading such highly recalcitrant polychlorinated and polyaromatic pollutants as hexachlorobenzene, DDT, heptachlor, aldrin, endosulphan, benzopyrene, benzofluoranthene, and benzoperylene in aqueous solution under ambient conditions.

A wide variety of microbially-mediated precipitation mechanisms may be exploited, and a wide range of inorganic catalysts, nanocatalysts, and nanophase materials can be prepared, in accordance with the present invention. The mechanisms involved include but are not limited to, for example, direct redox transformation of ionic species that result in the formation of less soluble species; microbial alteration of the environment (e.g., change in pH) that results in precipitation; microbial excretion or secretion of metabolic products (e.g., carbon dioxide, or sulfide, or phosphate ions) that interact with inorganic species to produce precipitates; and the like. Since such mechanisms function in semi-solid (e.g., gel or agar), aqueous, and/or gaseous media comprising inorganic ions, salts, buffers, nutrients, substrates, and/or dissolved gases, and similar constituents, simple incubation procedures and conventional or slightly modified incubation, fermentation, or chemostat equipment may be used in the production of nanophase materials. The inorganic materials that can be produced and used in accordance with the present invention include, but are not limited to, for example, (hydr)oxides, sulfides, phosphates, sulfates, carbonates, silicates, elemental metals and metalloids, and mixtures thereof, and the like.

Further, the nature and the chemical and physical properties of the microbially-produced precipitates can be altered, and the formation of specific inorganic catalysts, nanocatalysts, and other nanophase materials with desirable properties can be controlled, in accordance with the present invention, through simple techniques such as the choice of the microorganism to be used, a variety of simple techniques to alter the microbial preparation, and the choice of the incubation medium and conditions.

Microorganisms interact with bulk environments through a wide variety of mechanisms and their metabolisms are affected by a wide variety of phenomena. Altering the incubation conditions may cause the microorganism to interact with its bulk environment in different ways and thereby create different extracellular microenvironments. As will be shown, variables that may be used to affect or control precipitate formation include, but are not limited to, for example, the nutrients used and their relative proportions, the presence and concentrations of dissolved gases, the initial pH and/or mechanisms for controlling pH during the incubation period, the initial redox potential and/or mechanisms for poising and/or controlling the redox potential during the incubation period, and the presence/concentration of complexing or chelating agents, substrates, and/or inhibitors. Factors in the environment that may also affect the microorganisms, their metabolisms, and their inorganic precipitate formation processes are not limited solely to chemicals associated with the incubation medium itself. Environmental conditions that may also be altered or controlled to affect the chemistry and properties of the extracellular precipitate that is formed include but are not limited to, for example, light and the wavelengths and intensities thereof, temperature, pressure, pH, and the like. Therefore, a single microorganism can be caused to produce a variety of different nanophase materials by altering the incubation conditions under which the precipitate is formed, i.e., by altering the composition of the incubation medium, the environmental conditions, and the length of time the incubation is permitted to continue, as will be shown.

Because different microorganisms possess different metabolic properties and therefore establish different internal and external microenvironments, it has now been found that one microbe may produce extracellular precipitate materials that differ significantly from the extracellular precipitate materials produced by another, even when both microbes are grown and incubated under the same conditions.

Further, it has now been shown that, in many instances, the extracellular inorganic precipitation processes themselves can be directly controlled by the cell. Many microbial cells have developed unusual mechanisms for interacting with inorganic ions such as metal and metalloid ions in the surrounding aqueous environment, as a means of protection against toxic metals and/or a means of scavenging trace essential nutrient ions. It has now been shown that these unusual mechanisms directly affect the type and chemistry and properties of the precipitates that are formed outside the cell, and that different microorganisms can therefore be used to produce different inorganic precipitates even when the microbes are incubated in the same medium under the same conditions.

While a single type or strain or isolate of microorganism may certainly be used as the microbial reagent in accordance with the present invention, the use of multiple strains or types or mixed cultures may be used instead. Microbial reagents comprising mixed cultures of more than one type of microorganism may enable the use of microorganisms that do not survive readily and/or precipitate the desired inorganics as isolates.

Hence, by selecting the appropriate microorganism(s) and the appropriate incubation conditions, a wide variety of inorganic materials with unusual and/or desirable properties may be produced. By using microorganisms incubated, especially in semi-solid or aqueous media, under relatively moderate conditions, nanophase materials such as nanocatalysts can therefore be produced very simply and inexpensively, in accordance with the present invention.

While mild, ambient conditions certainly may be used in the microbially-mediated production of extracellular precipitates in accordance with the present invention, more stringent or harsh conditions may be preferable for the production of certain types of inorganic products. Due to thermodynamic constraints, certain types of precipitates can be expected to form only under conditions of very low or high pH, redox potential, temperature, salt concentration, and/or metal concentrations, even with microenvironment manipulation by a microorganism. Microorganisms that are sensitive to environmental extremes will therefore not be capable of producing these precipitates, simply because they cannot survive under the requisite incubation conditions. Hence, the ability to survive the rigors of harsher environments can enable a microbe to produce unusual metal precipitates. Microorganisms that have adapted to unusual environments often have developed different and unusual ways of interacting with metals that may yield different precipitates, as well. Nevertheless, the harsher environments needed to utilize the full range of microorganisms and extracellular inorganic precipitation mechanisms available for producing the full range of extracellular precipitates possible in accordance with the present invention are still far less harsh, and far easier to establish and maintain, than those required for prior art nanophase material production.

“Natural” microbial processes may not produce precisely the nanophase precipitate that is desired; microorganisms may be modified for use as microbial reagents in accordance with the present invention. It is possible to affect, modify, tailor, and enhance the properties of the inorganic materials produced in accordance with the present invention by modifying the properties of the microbial preparation (i.e., the microbial reagent) used in the production of the precipitate. Techniques that may be used in preparing the microbial reagent include but are not limited to, for example, genetic engineering to alter the proteins involved in the metal precipitation processes; selection of the appropriate nutrients and incubation conditions used in growing up the microbial reagents to induce the formation of select biological macromolecules or otherwise influence metabolic pathways; altering the permeability of the cell membrane of the microbe(s), disrupting pH gradients, and/or decompartmentalizing cellular constituents; stressing to induce the loss and/or overproduction of various enzymes and other biological macromolecules, inhibiting various metabolic pathways or pathway constituents or enzymes; isolating cell fractions or organelles or constituents; and like techniques that will be apparent to those versed in the art.

Post Treatment

Finally, it has also now been found that the unique inorganic precipitates formed extracellularly by microorganisms interact with various media, often in different and unusual ways; and it is therefore possible to further modify, tailor, improve, or enhance the performance or properties of the microbially-produced inorganic materials through the use of one or more simple, inexpensive post-treatment processes. Such post-treatments include but are not limited to, for example, secondary microbial/biochemical, chemical (liquid or gas), thermal, pressure, irradiation, aging, drying, and/or separation treatments, and the like.

It is apparent that the present invention offers many advantages over the prior art for the production of inorganic catalysts, nanocatalysts, and nanophase materials. For example, prior art techniques are usually limited to the production of a small range of inorganic materials. The present invention, however, offers many different simple manipulations which may be used in tailoring catalysts, nanocatalysts, and nanophase materials comprised of many different inorganic constituents or mixtures thereof, for specific applications. In addition, the present invention can be used to produce catalytic and nanophase materials that are different from those that may be produced by prior art techniques, with unique physical and chemical properties that differ from the properties of inorganics produced by prior art techniques. Prior art nanophase material production techniques involve sophisticated processes, elaborate equipment, and expensive chemicals. The present invention involves simple, straightforward incubation or ‘fermentation’ techniques, and requires only simple equipment, microbial preparations, and inexpensive additives. Prior art techniques are inefficient, produce hazardous wastes, and consume high levels of power. The present invention is highly efficient, produces few or no hazardous wastes, and consumes very little power. The costs for producing the catalysts, nanocatalysts, and nanophase materials in accordance with the present invention will therefore be very favorable in comparison with prior art techniques.

Examples are provided below of some of the different types of microorganisms and their extracellular precipitation processes that may be used in accordance with the present invention, the different methods that may be used for preparing the microbial reagents for use in producing the extracellular inorganics, the different incubation parameters that can be adjusted to control the inorganic precipitates that are produced, and the various post-treatments that can be used to further modify and/or enhance and/or tailor the inorganic precipitates to yield a nanophase material, catalyst, or nanocatalyst or with the desired properties. It should be noted that the present invention is not limited to these examples, however, which are provided solely for purposes of illustration and should not be taken in a limiting sense.

### EXAMPLE 1

### Production of Nanophase Metal (Hydr)oxides by Microbial Reagents

Metal oxides, especially ultra-high-surface-area iron and manganese oxides, are of considerable interest for catalyst applications. Microorganisms have long been recognized for their ability to deposit iron and manganese (hydr)oxides extracellularly (W C Ghiorse, Ann Rev Microbiol 38, 515-550, 1984); the classical “iron bacteria” Gallionella, Sphaerotilus, Leptothrix, and Clonothrix were all described during the nineteenth century. The types of microorganisms now known to be involved in ferromanganese precipitating activity include not only bacteria, but also fungi, algae, and protozoa. They have been detected in samples from almost every compartment of the biosphere where iron hydroxide and ferromanganese oxide deposits are found, ranging from deep-sea hydrothermal vent regions, to fjords, to the surface of desert rocks. They occur in ocherous and ferromanganese deposits that form in neutral waters of lakes, ponds, swamps, bogs, drainage ditches, and chalybeate springs. They also occur in wells and water-distribution systems, where they can cause significant clogging problems. It has been established that ferromanganese deposits associated with microbial activity also sequester many other metals, and hence microbial formation of iron and manganese oxides may influence the concentrations and accessibility of many different metals in natural environments (E A Jenne, in Trace Inorganics in Water, R. F. Gould, ed, American Chemical Society, Washington, pp 337-387, 1968). Yet despite the environmental and economic importance associated with the ability of these microorganisms to accumulate large amounts of iron and manganese from very dilute solutions, the mechanisms of metal binding and oxidation are poorly understood (W C Ghiorse, in Biotechnology and Bioengineering Symp No 16, John Wiley & Sons, Inc., New York, pp 141-148, 1986; K H Nealson, R A Rosson, and C R Myers, in Metal Ions and Bacteria, T J Beveridge and R J Doyle, eds, John Wiley and Sons, New York, pp 383-411, 1988).

Because many different metals have been enriched in marine ferromanganese nodules (the metals that are partitioned into these minerals include Hg, Pb, I, Ba, Ce, Cr, Th, U, Co, Ra, Ni, Zn, Cd, Ag, Sn, Sb, Tm, Yb, W, and Tl), the adsorption of metals on synthetic oxides and ferromanganese nodules has been studied extensively. It is known that the Mn octahedral lattices of manganates have net negative charges, distinguishing them from Mn oxides and oxyhydroxides. This negative charge can result from substitution of Mn(II) or Mn(III) for Mn(IV) or from vacancies of the Mn atom. The negative charge of the Mn [symbol] O framework must be balanced by positive cations, which explains the excellent cation exchange properties of manganates. Depending on the ionic strength and balancing cations present, manganates can either occur as layered or tunneled structures, both of which have strong adsorption characteristics. The enrichment of certain metals, such as Hg, Pb, Ni, and Cu, in ferromanganese nodules has been explained based on these adsorptive properties. Some researchers argue that microorganisms were involved in the formation of marine ferromanganese nodules, although the role that microorganisms may have played in the initial formation of these nodules is still very much open to debate. More recently, a handful of researchers have started to investigate the role that microbially-formed ferromanganese (hydr)oxides may play in the environmental fate of organics such as certain priority pollutants; although as discussed elsewhere, these investigations have similarly relied exclusively on studies conducted with synthetic ferromanganese materials produced by conventional chemical precipitation techniques. The metal ion adsorptive properties of the microbially-produced ferromanganese (hydr)oxide precipitates themselves have never been characterized, let alone the catalytic properties of microbially formed extracellular manganates or iron or manganese oxides, since it has been assumed that they possess the same chemical and physical properties as synthetic minerals produced by conventional chemical precipitation processes. At best, it has been recognized that different environmental conditions may result in the formation of different extracellular precipitates (since different chemical conditions result in different chemically precipitated minerals), and, hence, preliminary studies have been performed to ascertain some of the chemical and physical properties of the microbial products. Those few studies undertaken to “identify” microbially-produced ferromanganese precipitates have invariably defined these extracellular precipitates in terms of convention minerals.

It has now been found that the extracellular (hydr)oxide precipitates that are formed by at least some microbial processes possess unique chemical and physical properties that differ from metal precipitates formed by convention routes; and that it is possible to control the formation of these precipitates through a variety of mechanisms in order to control the formation of unusual or unique catalysts and nanocatalysts with desirable properties, such as the ability to catalyze the degradation of recalcitrant organics far more rapidly than synthetic metal (hydr)oxide precipitates.

In one preferred form of the invention, a microorganism capable of direct redox transformation of certain transition metals such as manganese may be incubated in a solution containing one or more of those metals to produce an extracellular precipitate. For example, it has now been found that a single strain of a manganese-oxidizing microorganism may be used to produce different Mn(III,IV) oxides and manganate precipitates by incubating the microorganism in a solution and altering and controlling such incubation factors as the Mn(II) concentration, the temperature, the pH, the osmolarity of the medium, and/or the presence of trace ions; and that the nanophase materials so produced, although resembling conventional precipitates in some ways, are different and unusual materials with different and unusual properties. It has also been shown that the length of time the microbial reagent is incubated in the medium can be used to tailor or modify or enhance the materials produced in accordance with the present invention.

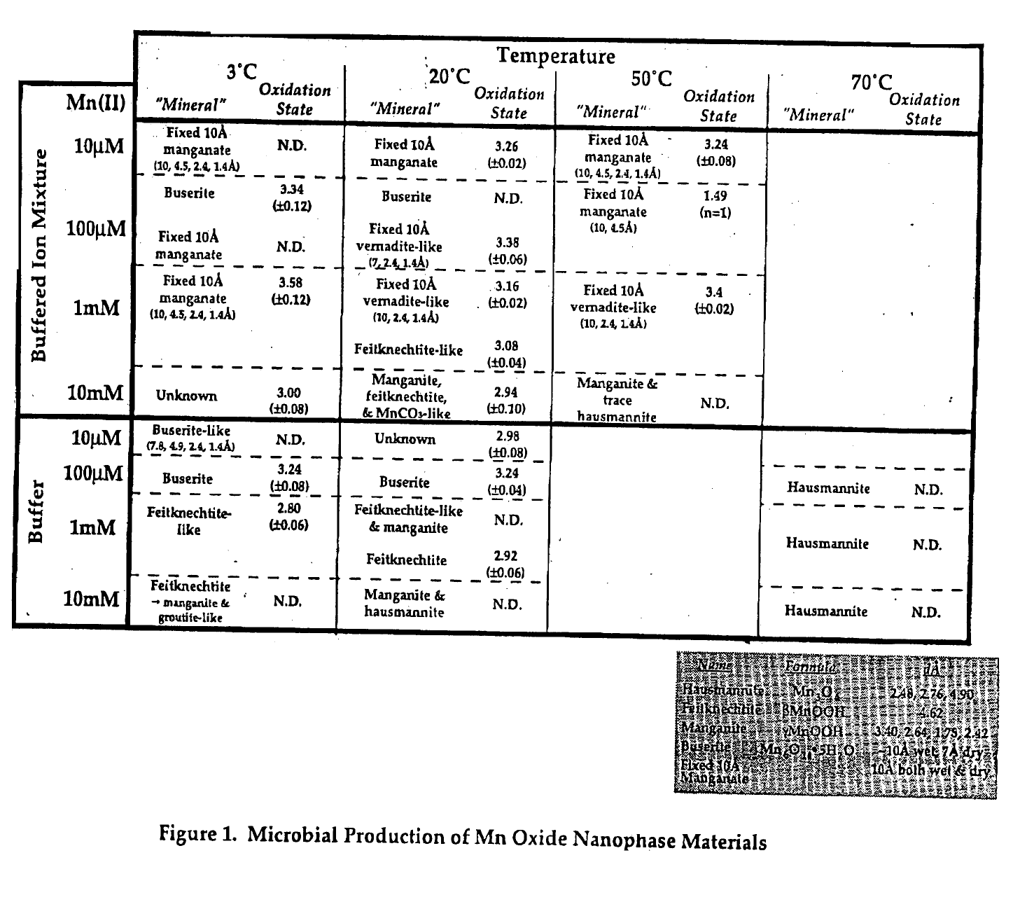

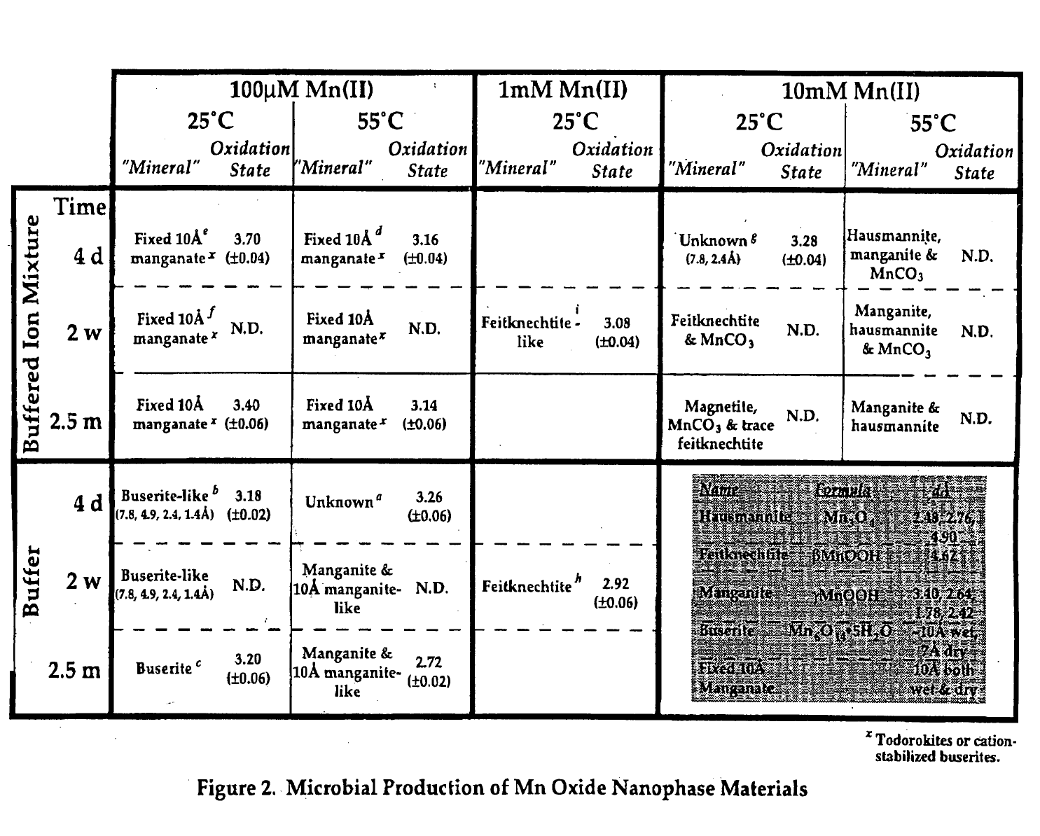

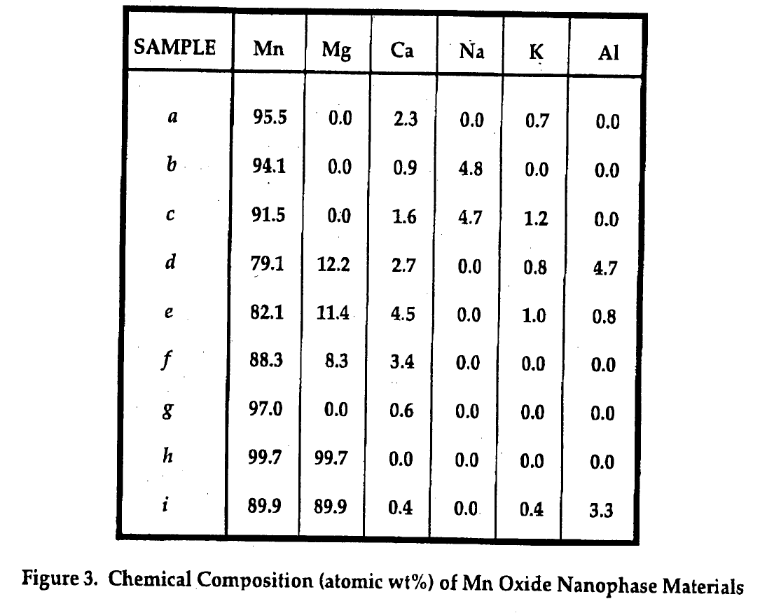

For example, the spores of the marine Bacillus SG [symbol] 1 may be used in accordance with the present invention to produce a variety of extracellular precipitates resembling not only the lower valence state Mn minerals hausmannite, feitknechtite, and manganite that other researchers have suggested (J D Hem and C J Lind, Geochim Cosmochim Acta 47, 2037-2046, 1983) will be formed by microbes, but also extracellular precipitates resembling todorokite, birnessite, buserite, and rhodochrosite, as well as a number of unusual, Ca- and Mg-rich manganates that do not resemble any known synthetic minerals. While some incubation conditions consistently yielded non-collapsible 10 Å phases that resembled todorokite, other fixed lot manganates appeared to be cation-stabilized buserites, while yet others resembled vernadites. Examples of the various nanophase Mn oxide materials that can be produced in accordance with this invention, and some of their properties, are shown in FIGS. 1-3.

It has been shown that these nanophase materials differ from Mn oxide and manganate standards from mineral index files provided by the Joint Committee for Powder Diffraction Studies and from well-characterized samples in the mineral collection at the Smithsonian Institution, when analyzed by electron microscopy, powdered X-ray diffraction, energy dispersive spectroscopy, and modified iodometric techniques to determine oxidation state. In general, the lower valence minerals formed in accordance with this invention, such as those resembling Mn₃O₄, g-MnOOH, b-MnOOH, and MnCO₃, were microcrystallized, while the higher valence state precipitates, such as those resembling buserite, typically yielded powder X-ray diffraction (XRD) patterns indicative of amorphous and/or highly disordered precipitates. The fixed 10 Å dimension of some of the non-collapsible manganates produced in accordance with the present invention is probably the result of Mg, and to a lesser extent Ca, intercalated between MnO₆ octahedral layers. The Mg/Mn ratio (atomic weight %) of the fixed 10 Å microbially-produced manganates was as high as 0.15; this is very high in comparison to the Mg/Mn ratios of 0.08 found in natural buserites. In nature, Mn oxidation and disproportionation reactions do not tend to equilibrium, but instead proceed unidirectionally, i.e., oxides disproportionate only to higher valence state minerals. Therefore, of particular interest was the microbial production of a precipitate with an initial relatively high oxidation state of 3.28 that decreased, rather than increased, with time to 2.84. This precipitate appeared to be similar to birnessite, with distinct XRD peaks at 7.8 and 2.4 Å; however, EDS analysis did not reveal the presence of significant levels of Na, Mg, or Ca within the mineral structure that would be expected of conventional manganates.

Of most importance, it has been shown that the precipitates thus produced in accordance with the present invention have exceptionally high surface areas by comparison against those of known Mn minerals, and by comparison with nanophase oxides formed by prior art techniques such as those described earlier. It has also now been shown that these ultra-high surface area microbial metal (hydr)oxides are significantly more reactive toward the oxidation of organic compounds and metal ions than comparable synthetic oxides. For example, it has been shown that Mn (hydr)oxides produced in accordance with the present invention are capable of degrading extremely complex polyaromatics such as fulvic acids, producing simple, low molecular weight organic compounds such as pyruvate and acetone (both of which subsequently underwent further oxidation by the metal precipitate), formaldehyde, and acetaldehyde. It has also been shown that the Mn precipitates formed by the microorganisms are capable of degrading humic substances to simple carbonyls that can be used as nutrients and thereby further degraded or mineralized by the microbes themselves.

Among the many other advantages of using microorganisms such as Bacillus SG [symbol] 1 spores to produce Mn materials are the speed and efficiency of the Mn oxidation and precipitation process. The rates of Mn²⁺ oxidation by the spores at neutral pH are more than five orders of magnitude faster than would occur by chemical mechanisms. The spores have been shown to be capable of producing up to six times their own dry weight in manganese oxides within two hours, depending on the incubation parameters. It is known that chemical oxidation proceeds by a two-step process involving the initial precipitation of lower valence state oxides which then disproportionate to Mn(IV) minerals. It has now been shown that certain microbial strains catalyze the direct oxidation of Mn(II) to Mn(IV). High Mn(II) concentrations impede chemical oxidation of lower valence minerals to Mn(IV) minerals; yet it has now been shown that microorganisms can produce Mn(IV) precipitates at Mn(II) concentrations too high for disproportionation reactions to Mn(IV) to have been thermodynamically feasible. In addition, the spores may be used to produce nanophase materials comprising other elements including not only Mn, but also Fe, Co, Pb, Cu, Cd, Ni, and Zn, and mixtures thereof, in accordance with the present invention.

It should be noted that the present invention is not restricted to the use of the marine Bacillus SG [symbol] 1 spores, but can be used with any microorganism capable of producing extracellular (hydr)oxides. In fact, the selection of microorganisms is one of the tools that can be used to tailor the structure and composition of nanophase materials, since it has now been shown that different microbes when incubated under the same conditions form different extracellular precipitates with different chemical and physical properties, i.e., that the microbes themselves have a direct influence on the structure and chemistry of the precipitate that formed. It has been shown that different microbes incubated under the same conditions yielded 10 Å manganate products with different mineral structures and different Mg/Mn, Ca/Mn, and Na/Mn ratios. For example, in a buffered ion mixture containing low concentrations (100 μM) of Mn(II) at 25° C., the marine Bacillus SG [symbol] 1 spores produced disordered or microcrystalline, non-collapsible, fixed 10 Å manganates rich in Mg and Ca, whereas a different microorganism (from a marine enrichment) incubated under the same conditions yielded a well-crystallized 10 Å Mn(IV) manganate with much lower Mg/Mn and Ca/Mn ratios and a much higher (0.08 vs 0) Na/Mn ratio. It has also been shown that precipitates formed during short incubation periods had far higher Mg/Mn ratios than those formed during longer incubation periods; i.e., at longer incubations, autocatalysis, chemisorption, and adsorption mechanisms took over and began to ‘erase’ the earlier influence of the Bacillus spores or cells on the cation content of the precipitates.

It has been found that the oxidation products of iron and manganese may be accumulated on cell surfaces not only of the oxidizers but also of other microorganisms. Although the present invention is not bounded by theory, the inventor believes that the nucleation site at which the nanophase material first starts to form can have a significant impact on the properties of that nanophase material. Hence, in one preferred form of the invention, a mixed culture containing microorganisms whose cell envelopes serve as nucleation sites in addition to microorganisms that oxidize iron and/or manganese is used in the production of extracellular nanophase precipitates.

As will be apparent, many incubation medium parameters may be altered or controlled to affect or control precipitate formation and the chemistry and properties of the precipitate that is produced. These parameters include, but are not limited to, for example, the nutrients used and their relative proportions, the presence and concentrations of dissolved gases, the initial pH and/or mechanisms for controlling pH during the incubation period, the presence of trace ions, and the presence/concentration of complexing or chelating agents, substrates, and/or inhibitors.

In yet another preferred form of the invention, the presence and concentration of various gases in the incubation medium can be used to control, modify, and tailor the nanophase materials that are formed by the microorganisms. Dissolved oxygen concentrations, for example, can have numerous effects on microbial metabolism and the microenvironment surrounding the microbe; it should be noted that the present invention is not bounded by the phenomena involved, but only by the ultimate effect of using dissolved gases as one of many simple techniques to affect and control the formation of the desired nanophase material. For example, microorganisms such as Leptothrix pseudoochraceae, Arthrobacter siderocapsulatus, and Metallogenium personatum may oxidize Mn²⁺ and Fe²⁺ enzymatically (e.g., via catalase mediation) by reaction with small amounts of H₂O₂ produced during aerobic growth of the bacteria on glucose or other organic substrates. If H₂O₂ were produced in the periplasmic space of microorganisms during oxidative metabolism, it might diffuse outward and be eliminated extracellularly by either enzymatic oxidation or nonenzymatic reduction. If such a mechanism were operating under oligotrophic and microaerophilic conditions, low levels of H₂O₂ would be produced under these conditions and could participate in peroxidase-oxidation and subsequent deposition of metal oxides. On the other hand, under fully aerobic conditions with excess organic nutrients, excess H₂O₂ would be produced, and reduction of metal oxides would be expected at moderately low pH. Hence, with judicious selection of the microbial strain and nutrients, and by control of the pH and O₂ concentration, the formation and fate of H₂O₂ can be exploited to control and affect extracellular nanophase oxide formation. In yet another example of a preferred form of the invention, iron-reducing bacteria may be cultured under low dissolved oxygen tensions (less than 5% of air saturation) to enzymatically reduce iron, uranium, and cobalt to produce extracellular metal precipitates; cells cultured with higher dissolved oxygen tensions (50-100%) do not exhibit metal reductase activity. Therefore, dissolved oxygen concentration can be used in accordance with the present invention to control the formation of extracellular precipitates.

Many other dissolved gases can also be used to affect the formation and chemistry of extracellular precipitates and can affect the ultimate precipitate formation processes via a variety of mechanisms. For example, gaseous CO₂ can have multiple effects such as altering pH, and thereby affecting the chemistry of the extracellular precipitate; and causing the incorporation of carbonates into the precipitate lattice. Purging the incubation medium with an inert gas, such as argon, can alter the normal balance of gases produced by an organism (including CO₂), and thereby affect metabolism, the microenvironment, and the properties of the microbially-produced metal precipitate. Similarly, other gases may be used to tailor or modify the precipitate that is formed during the incubation, through any of a wide variety of mechanisms.

It has been shown that the initial pH of the incubation medium may be used as a tool to alter and affect the precipitates that are formed in accordance with the present invention. The mechanisms and chemicals used for establishing the initial pH and controlling pH throughout the incubation may affect the chemistry and properties of the precipitates that are formed through a variety of mechanisms. Although the present invention is not bound by theory, a basic understanding of some of the mechanisms that may be involved are useful in determining the parameters to be used in precipitates with the desired properties. It should be noted, for example, that many chemicals commonly used as buffers can also act as complexing agents. Acetate and phosphate, for example, can both affect the interactions between metal surfaces and metal ions and the interactions between metal surfaces and organics, as well as the pH of the incubation medium. Acetate is known to chemisorb as the carboxylate anion on oxide surfaces, and has been shown to block reductive dissolution by organics. Conversely, acetate can complex with the Mn²⁺ ions released by reductive dissolution. Buserite is known to have a high preference for Mn²⁺, which can selectively exchange other interlayer cations and thereby block reactions with organics. When acetate is present, buserite oxidation of organics is facilitated by acetate complexation with the Mn²⁺ formed by reductive dissolution, thus exposing ‘clean’ reactive surfaces. On the other hand, since the Mn²⁺ in solution is complexed, its activity in solution is likely to be much lower than its actual concentration, making the reduction potential of the system more positive. Accordingly, the use of an acetate buffer may affect such processes as interactions between the Mn precipitate and other organic constituents in the incubation medium (thereby affecting both the precipitate and the organics, and possibly affecting the microbial metabolism dependent upon the organics), interactions between the Mn precipitate and Mn ions, and the like, and thereby affect and alter the precipitate that is formed. Phosphate ions bind readily to natural and man-made Fe and Mn minerals and surfaces; the bound phosphate is usually somewhat protective and is known to slow interactions with other solution constituents. Phosphate ion has been observed to inhibit the reductive dissolution of Mn(III,IV) oxides by hydroquinone; experiments indicated that O₂ was released into solution by excess phosphate, possibly a consequence of PO₄ ligands exchanging O₂ from coordination positions on surface Mn.

The salt content of the incubation medium may also be altered to affect and control the production of desired precipitates in accordance with the present invention. For example, mixed minerals containing MgO and/or CaO have exceptionally high reactivities. It has been shown that trace cations such as Mg and Ca may be readily incorporated into microbially-produced extracellular Mn oxides at unusually high levels; and the presence of high levels of Mg and/or Ca in the microbial products was found to affect the structure and properties of the precipitates. Under certain incubation conditions, one microbial strain produced minerals with XRD patterns suggesting a structure similar to buserite; significant levels of Na were observed in the precipitates, indicative of Na buserite. Precipitates formed under the same conditions but in media containing a variety of trace ions, however, consistently yielded non-collapsible 10 Å phases which, in this respect, resembled todorokite. Magnesium is believed to be an important structural cation for todorokite or for fixed 10 Å phyllomanganates. Significant levels of Mg and some Ca in the precipitate was confirmed by energy dispersive spectroscopy (EDS) analysis. The Mg/Mn ratio (atomic weight %) of the fixed 10 Å microbially-produced manganates was twice as high as Mg/Mn ratios found in natural buserite minerals. In other respects, the precipitates resembled Mg/Ca-stabilized buserites. Non-collapsible structures supported by high concentrations of Mg can permit a higher surface area and/or the presence of reactive sites with configurations that differ from those in collapsed 7 Å structures. Some 10 Å forms, e.g., todorokites found in deep-sea manganese nodules, have crystalline channels (pores) within their mineral structure that allow them to absorb and release positively charged cations; and the Mn within the mineral lattice can accept varied numbers of electrons. The production of oxides with controlled pore sizes, cation exchange capabilities, and MgO and CaO structures may be highly desirable for use as, for examples, nanocatalysts.

For some applications, it may be preferable to produce a nanophase material that is completely separated from all biological materials such as the cell envelope. Again, through judicious selection of the microbial strain and the incubation medium, a cell-free nanophase material may be produced in accordance with this invention. For example, in another preferred form of the invention, cultures of Mn-depositing fungi may be incubated in Mn media that contains starch or agar to produce extracellular Mn-oxide precipitate particles near, but not directly attached to or associated with, the fungal hyphae. It has been found that these particles, when examined in thin sections, contained no membranes or other cellular structures, nor did they stain with acridine orange.

As has been noted, environmental conditions such as temperature may affect the chemistry and properties of extracellular precipitates produced in accordance with the present invention. Other environmental conditions may be used to control or alter the products that are formed as well. For example, pressure may also be a useful parameter in controlling the type of nanophase material that is produced in accordance with the present invention. Barophilic manganese-oxidizing bacteria have been isolated from ferromanganese nodules from the deep sea and around hydrothermal vents. Such microbes possess unusual means for interacting with inorganic ions and may be exploited in the production of novel nanophase materials with unusual properties.

It should be noted that manganese precipitates are not the only nanophase (hydr)oxides that can be produced in accordance with the present invention. Nanophase materials comprising many other metals and metalloids and mixtures thereof can be produced by microbial extracellular precipitation processes. For example, microbial Fe(III) reduction, e.g., by dissimilatory Fe(III)-reducers such as Geobacter metallireducens and Shewanella putrefaciens, can be used in the production of a variety of Fe-containing precipitates, just as microbial Mn(II) oxidation can be used in the formation of a variety of Mn-containing precipitates. Alternatively, it has now been shown that some manganese binding and oxidizing proteins have an affinity for other metals besides manganese. For example, it has been shown that the marine Bacillus spores are capable of oxidizing zinc and cobalt, in the presence or even in the absence of manganese. Hence, these microorganisms may be used to produce nanophase materials containing a variety of metals and metal mixtures in accordance with the present invention. As before, the structure, composition, and properties of these nanophase materials can be controlled, tailored, and modified through the selection of the microorganism that is used in their production, and the conditions under which the microorganisms are incubated, e.g., the various ions and their concentrations, temperature, pH, dissolved gases, pressure, length of incubation, and the like. Iron- or manganese-free nanophase materials can be produced, even in the presence of iron and/or manganese for example, by incubating such microorganisms under environmental conditions (e.g., low pH, anaerobic) that do not allow manganese or iron oxides to form. Nevertheless, the presence of the iron and manganese can affect the environment and thereby affect the structure and properties of the nanophase materials that are produced.

Other types of microorganisms may also be used to produce nanophase metal (hydr)oxides in accordance with the present invention. Many different types of organisms are capable of forming many different types of oxides, including oxides that do not contain Mn or Fe. For example, a wide variety of metal oxidation and reduction (redox) reactions are catalyzed by microorganisms. Often these redox transformations bring about the precipitation of solid phases because the new metal species has reduced solubility. For example, microbial oxidation of soluble Co and Cu ions as well as Fe and Mn ions leads to the formation of insoluble metal hydroxides, oxyhydroxides, or oxides [collectively referred to as (hydr)oxides herein]; while microbial reduction of soluble Cr, Se, U, Tc, Au, Ag, Mo, and V ions leads to the formation of insoluble (hydr)oxides and elemental metal precipitates. In some instances, direct enzymatic redox transformation of the ion results in its precipitation; in others, the mechanisms and phenomena underlying the formation of the precipitate are unknown. It should be noted that the present invention is not bounded by the underlying mechanism or phenomena involved in inducing the formation of extracellular precipitates; both direct and indirect extracellular precipitation processes may be exploited in accordance with the present invention.

In yet another preferred form of the invention, a microorganism capable of reducing oxidized forms of selenium may be used in the production of extracellular selenite precipitates. For example, a Bacillus megaterium strain may be used to oxidize elemental selenium and produce an extracellular selenite precipitate, SeO, in accordance with the present invention. Similarly, other organisms may be used to produce extracellular selenium precipitates, either pure materials or mixtures with other inorganics. For example, various species of Clostridium, Citrobacter, Flavobacterium, and Pseudomonas may be used to produce nanophase extracellular precipitates comprising elemental selenium by incubation in solutions containing selenate and/or selenite, in accordance with the present invention. Citrobacter spp. may be incubated in solutions containing soluble selenate to transform the selenate to elemental selenium and precipitate it extracellularly. As with the other examples cited herein, the choice of the microorganism, its preparation for use in nanophase material production, and the conditions under which it is incubated can be used to control, tailor, and modify the properties of the selenium oxide(s) that are produced.

In still other preferred forms of the present invention, various microorganisms that enzymatically reduce metals such as chromium, uranium, technetium, vanadium, molybdenum, gold, silver, and copper may be used to produce extracellular precipitates containing one or more of these inorganics in accordance with the present invention. Examples of such forms include, but are not limited to, the following. Extracellular nanophase materials containing chromium may be produced by incubating microorganisms such as various Pseudomonas and Streptomyces spp., Aeromonas dechromatica, Bacillus cereus, B. subtilis, Achromobacter eurydice, Micrococcus roseus, E. coli, or Enterobacter cloacae in solutions containing Cr(VI). For example, in one preferred form of the invention, extracellular chromium precipitates may be produced by growing Pseudomonas fluorescens LB300 aerobically in a glucose medium, or anaerobically on agar plates containing acetate. Extracellular nanophase materials comprising technetium may be produced by incubating Moraxella or Planococcus spp. in oxygen-depleted pertechnetate media or by incubating D. gigas or D. vulgaris with pertechnetate anaerobically. Similarly, nanophase vanadium materials may be produced by various Pseudomonas incubated under suitable conditions. Bacillus subtilis, Aspergillus niger, Cholorella vulgaris, and Spirulina platentis may be used to produce nanophase materials comprising elemental gold in accordance with the present invention; for example, B. subtilis may be incubated in solutions containing Au(III) chloride to yield nanophase granules of elemental gold, whereas C. vulgaris may be incubated in solutions containing Au(III), Au(I), or mixtures thereof. Alternatively, B. subtilis wall fragments may be used to produce nanophase crystallites comprising elemental gold. Dissimilatory Fe(III)-reducing microorganisms such as G. metallireducens may be incubated in solutions of Au(III), Ag(I), or mixtures thereof to produce nanophase materials containing these elements.

It should be noted that the present invention is not limited to the specific examples cited herein, but may be used with a much wider range of microorganisms, incubation media, and incubation conditions to produce a very wide range of extracellular nanophase materials.

### EXAMPLE 2

### Production of Nanophase Sulfides by Microbial Reagents

A number of metal sulfides have been used as catalysts and, more recently, studied for use in nanocatalysts, including Fe, Mo, and Cd sulfides. For example, over the years, MoS₂-based catalysts have proven to be of the utmost importance in industrial hydrotreating processes, including hydrodesulfurization, hydrogenation, isomerization and hydrodenitrogenation. Recently, studies have been conducted on the development of nanocatalysts for coal liquefaction. The catalyst is inevitably lost during the breakdown of the coal and thus an inexpensive, disposable material is required, which effectively limits the choices to iron oxides or iron sulfides. Although bulk iron sulfides, which have extremely low (usually <5-10 m²/g) surface areas, are noncatalytic, preliminary tests indicated that a 10 nm pyrite nanocatalyst significantly increased the yield of heptane soluable sols (J P Wilcoxon, T Martino, E Klavetter, and A P Sylwester, in Nanophase Materials: Synthesis Properties Applications, G C Hadjipanayis and R W Siegel, eds, Kluwer Academic Publishers, Dordrecht, The Netherlands, p 771, 1994). The processes and techniques used to create such sulfide nanocatalysts, however, are still expensive, inefficient, and limited to the production of only a few different types of nanophase sulfide materials.

The present invention may be used to produce a wide variety of nanophase sulfides with unusual and highly desirable properties, simply and inexpensively.

There are at least nine genera of sulfate-reducing bacteria (SRBs), i.e., the eubacteria Desulfovibrio and Desulfotomaculum and the more recently discovered Desulfobacter, Desulfosarcina, Desulfonema, Desulfobulbus, Desulfococcus, and Thermodesulfobacterium; and the archaebacterium isolated and described in 1987, tentatively called ‘Archaeoglobus fulgidus’. These genera constitute a biochemically, nutritionally, and morphologically diverse group. They have in common only their ability to utilize sulfate as a terminal electron acceptor and the fact that they are all strict anaerobes. Virtually all of the reduced sulfur is released into the external environment as the sulfide ion, causing heavy metal ions in the vicinity of the SRBs to precipitate as metal sulfides. Perhaps because oxides are believed to play an important role in metal cycling in the environment, there has been a reasonable amount of study into microbial formation of iron and manganese oxide precipitates. By comparison, microbial formation of sulfide precipitates has been largely ignored; and reference books with dozens of citations on oxides will, at best, show one or two on sulfides. As with the oxides, the microbially-formed sulfides have been assumed to be conventional minerals with conventional properties; and since conventionally produced metal sulfides usually comprise nonreactive, low-surface-area materials, microbially formed metal sulfides have garnered only cursory interest.

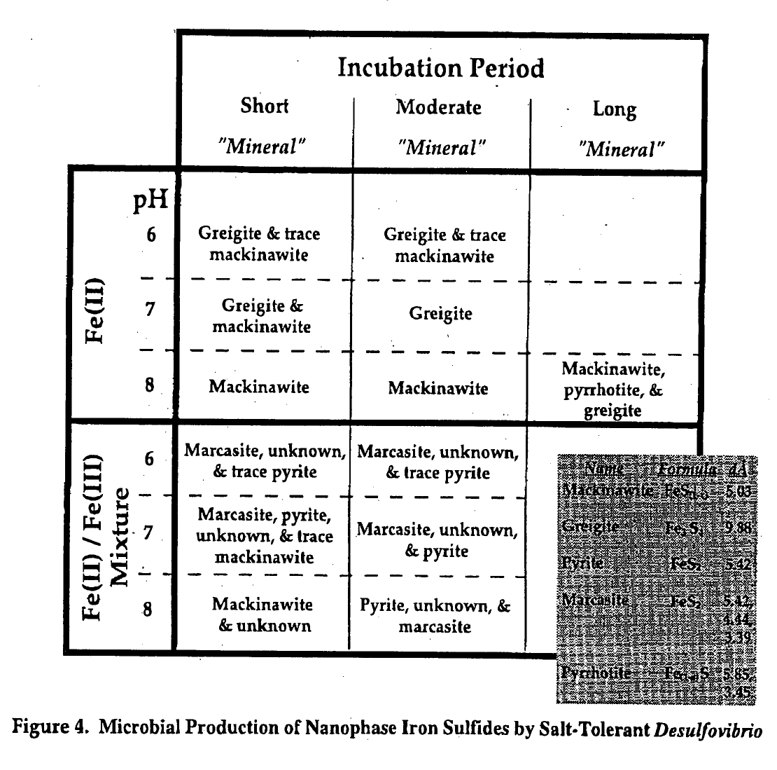

However, it has now been shown that microbial sulfate reduction and the ensuing extracellular precipitation of metal sulfides can serve as the basis for the production of unique nanophase metal sulfides with unusual and highly desirable properties. As discussed earlier, it has been shown that a variety of nanophase oxides may be produced by a single microbial strain in accordance with the present invention, simply by manipulating the incubation conditions. Similarly, it has now been shown that a single microbial strain may be used to produce a variety of nanophase metal sulfides in accordance with the present invention. For example, by modifying the source of the iron ions and the relative concentrations of ferrous and ferric ions and by adjusting the pH, a salt tolerant SRB incubated in the presence of iron and sulfate may be used to produce iron sulfide precipitates comprising relatively pure nanocrystallites or mixtures of nanocrystallites resembling greigite, mackinawite, marcasite, pyrite, and pyrrhotite, as determined by XRD and chemical analyses (see FIG. 4). Precipitates resembling greigite were favored by acidic conditions and/or higher temperatures, while those resembling pyrite were favored under more alkaline conditions and those resembling marcasite formed at lower temperatures. Incubation conditions that caused the chemical precipitation of some or all of the dissolved Fe prior to microbially-induced sulfide precipitation had a striking impact on the resulting microbially-produced nanophase sulfide precipitates. As with the microbial Mn oxides, as the SRB incubation period was lengthened, the structure and properties of the microbial sulfides changed. Some of these changes appeared to be due to continuing reactions influenced by the microbes; for example, precipitates that originally resembled relatively pure mackinawite later showed signs of greigite, apparently due to continued microbial production of the sulfide ion, which then reacted with the mackinawite. Continued production of sulfide also caused a transformation to pyrite, although this reaction tended to be favored under more alkaline conditions. Other changes were more reminiscent of Mn oxide disproportionation, e.g., the gradual transition of greigite to pyrrhotite. It has also been shown that adding Cu, Ni, and/or Co ions to the incubation medium can affect the structure and properties of the sulfide that is formed; for example, these ions can be incorporated into mackinawites and can stabilize certain of their structures during post-treatment (e.g., heating, drying, or aging).

Oxides produced in accordance with the present invention have been shown to differ substantially from oxides produced by prior art techniques. Similarly, it has now been shown that extracellular microbially-produced iron sulfides may be strikingly different from iron sulfide precipitates that have been synthesized using prior art chemical precipitation or even innovative processes for producing nanocatalysts such as those described earlier. For example, one iron sulfide (an Fe_{0.7}S) produced in accordance with the present invention [i.e., by incubation at 32° C. of a Desulfovibrio sp. in modified Postgate's C (diluted 1:10, with added iron sulfate)] exhibited an extended X-ray absorption fine structure (EXAFS) pattern which cannot be fitted by known forms of iron sulfide. Its moisture content, measured by drying at 100° C. in vacuum for 5 hours, was determined to be 85.3%. The magnetic properties of the microbially-formed Fe_{0.7}S also indicated that the iron sulfide was a novel material; although it did not appear to contain a significant quantity of Fe₇S₈ or the highly magnetic Fe₃S₄ (the sulfide equivalent of magnetite), since the EXAFS data were considerably different from those reported for these two minerals, the microbial Fe_{0.7}S was 2-3 times more magnetic than expected. Scanning electron microscopy (SEM) analysis showed that the microbially-produced nanophase precipitate had an exceptionally high surface area in comparison with natural or synthetic iron sulfides; when examined by SEM, the microbial iron sulfide was found to be a cloud of densely intertwined, fine, fibrillar material of about 0.005 mm diameter. BET measurements on freeze-dried material confirmed that the nanophase Fe_{0.7}S had a surface area of 2,000 m²/g, a surface area that is extraordinarily high by comparison with iron sulfides produced by chemical precipitation under mild conditions. This metal sulfide nanocatalyst produced in accordance with the present invention was shown to be highly reactive with polyhalogenated and polyaromatic pollutants, including hexachlorobenzene, heptachlor and its cis-epoxide, aldrin, endosulphan and its sulfate, DDT and its analogs, carbetamide, chlorotoluron, fluoranthene, benzo(ghi)porylene, benzo(u)fluoranthene, indeno(123cd)pyrene, benzo(b)fluoranthene, and benzo(a)pyrene.

As with the oxides, a wide variety of new and unusual sulfides can be produced in accordance with the present invention, by selecting the appropriate microorganism and establishing the appropriate incubation conditions. For example, a mixed enrichment from marine sediments incubated in lactate, sodium carbonate, and iron sulfate at pH 6.5 and 27° C. yielded an unusual iron sulfide that is much more magnetic than that described above. This new material also has an exceptionally high surface area, by comparison with standard iron sulfides under SEM examination, and is also highly reactive. It differs significantly in its chemical and physical properties from the precipitate produced by another enrichment incubated under the same conditions. When a mixed culture enrichment was grown in a chemostat under one set of conditions, it yielded a nonmagnetic iron sulfide precipitate; when the lactate concentration was increased and 10 ppm phosphate were added to the incubation medium, the level of ferrous ion in the effluent dropped dramatically and the iron sulfide that was produced was strongly magnetic.

As with oxides, there are many incubation medium constituents that may be used, altered, or adjusted to cause the production of a given nanophase sulfide with desirable properties; and the mechanisms whereby such constituents affect the precipitate formation are many and varied. Nutrients, substrates, inhibitors or stimulators, redox poising reagents, pH buffers, chelating agents, dissolved gases, and other incubation medium constituents may be selected or tailored to affect the production of the nanophase material in accordance with the present invention. It should be noted that each of these potential incubation medium constituents may have multiple effects on the chemistry, composition, and properties of the nanophase material that is produced. A few examples of the various parameters that may be adjusted in accordance with the present invention are discussed in the following paragraphs. It will be apparent that many other constituents and/or parameters may be adjusted or altered as well; and that the present invention is not limited to those examples described herein.

A wide range of nutrients or substrates or the like may be used to control the growth, the metabolism, and the cellular products of SRBs and, by so doing, to control the production of sulfide nanocatalyst or nanophase material. Various nutrients and substrates may seem to be important only in whether or not they support growth; but can, in fact, affect the overproduction or underproduction of enzymes essential to the metal production process; support metal precipitate formation without supporting growth, or vice versa; alter cell metabolism in ways that alter the microenvironment immediately surrounding the cell; or allow/eliminate one or more routes whereby precipitates can be formed by a given microorganism. SRBs obtain the carbon and energy necessary for cell growth by various routes. Chemo-organotrophic growth may be at the expense of single organic carbon compounds, such as lactate, which provide a common carbon and energy source. Alternatively, the carbon and energy sources may be separate, and organic carbon compounds that are not assimilated for growth, e.g., formate or isobutanol, can serve as electron donors for energy generation while other carbon compounds are assimilated for growth (mixotrophic). Hydrogen may also serve as an electron donor in chemolithotrophic growth. The capacities for mixotrophic growth and for growth on a common carbon and energy source are not mutually exclusive. Selection of the nutrients may be used to tailor the growth conditions, sulfide production, and the sulfide precipitate that is formed. For example, substrates such as ethanol, isobutanol, and gaseous H₂ permit very poor or no growth, yet a very high yield of sulfide, and may therefore be used in the production of sulfide-rich precipitates in accordance with the present invention. At the other extreme, carbon sources such as pyruvate, choline, malate, or fumarate can be used to support growth for most Desulfotomaculum spp. and some Desulfovibrio spp. with no reducible sulfur compound. Such facultative ‘non-sulfate’ growth is in some senses analogous to the fermentative growth of a facultative anaerobe, and yields organisms uncontaminated with sulfide. These species and carbon sources may therefore be used in accordance with the present invention to produce precipitates solely formed via redox mechanisms by SRBs, e.g., chromium, uranium, gold, and/or technetium precipitates uncontaminated with sulfide precipitates.

The role that certain nutrients might play in the production of extracellular sulfide precipitates may be more readily apparent than others. For example, various of these carbon sources can chelate metal ions and therefore affect their availability for incorporation into the forming precipitate. Certain carbon sources result in the formation of CO₂ and may therefore lead to changes in the local pH and/or incorporation of carbonate into the extracellular precipitate, as well as the production of carbonate which is a chelating agent. Certain substrates (e.g., citrate) prevent the precipitation of metal sulfides until high sulfide concentrations are reached, presumably because citrate is a chelating agent for the metal ions. It is known that H₂S decreases the growth rate of various SRBS, and can, at high concentration, slow the growth rate to zero; it probably does so by rendering soluble iron insoluble by converting it to iron sulfide, and iron is an essential nutrient for the organisms. Growth of cultures in many media follows a linear rather than exponential course; exponential growth can be obtained in media containing chelating agents to increase the solubility of iron. Hence, chelating agents may affect the production of nanophase sulfides through more than one route. Alternative routes for removing excess H₂S may or may not be preferable for the production of some nanophase materials, in accordance with the present invention.

Similarly, phosphate may affect the formation of a nanophase sulfide by a variety of mechanisms. If phosphate ions are present, they may readily interact with and become adsorbed onto the sulfide precipitate surface. This may result in unusual activated phosphoric sites. It may also minimize or limit interactions with various incubation medium constituents, since a phosphate coating tends to be somewhat protective. On the other hand, ferric phosphates can be converted to iron sulfides by SRB activity, releasing the phosphate ions. Hence, phosphate nutrients or their metabolic products may interact with a forming sulfide or mixed oxide/sulfide nanocatalyst. It has been shown that phosphate uptake by cell suspensions may be coupled with sulfate reduction; inhibiting the uptake of phosphate can actually stimulate the rate of sulfate reduction in H₂.

The choice of the sulfur-containing substrate can affect the nanophase sulfide that is produced in accordance with the present invention, as well. Many SRBs contain enzymes that allow them to utilize as many as possible of the free sulfur compounds usually available in nature. Although the primary diagnostic character of SRB is that they use sulfate as a terminal electron acceptor, reducing it to sulfide, other electron acceptors, i.e., sulfite, thiosulfite, thiosulfate, bisulfite, trithionate, tetrathionate, and dimethyl sulfoxide, and even elemental sulfur, can also be used by some genera. D. gigas, for example, is capable of utilizing elemental sulfur as its terminal electron acceptor instead of sulfate. A given reducible sulfur compound may be acted upon by the well-characterized sulfate reduction enzyme system or by one or more independent pathways. Therefore, by using different sulfur sources, it is possible to drive the utilization of different parts or components of the sulfate reduction chain and/or different pathways, which may in turn have an effect on the end product. If, for example, sulfite is used in the nanophase material production in place of sulfate, then two-thirds of the sulfate reduction chain can be eliminated, along with the effect of the involvement of this portion of the chain on the formation of the nanophase material. This, in turn, eliminates the need for ATP to activate sulfate in the production of sulfide, thereby enabling more efficient growth. A culture growing with a limited supply of lactate, for example, may reach a higher cell density with sulfite or thiosulfate than with sulfate, because the organisms have more ATP available for biosynthesis. It has been shown, for example, that molar growth yields of lactate-limited D. desulfuricans were 50% greater with sulfite than with sulfate. Similarly, thiosulfate enhanced the molar growth yield (related to the reducible substrate) over sulfate in mixotrophically grown D. vulgaris utilizing H₂, CO₂, and acetate; H₂ oxidation yielded three times as much net ATP with thiosulfate as with sulfate. It also means that more sulfide can be produced with far less microbial growth when substrates such as sulfite or thiosulfate are used in accordance with the present invention. This, in turn, means less metabolic activity, with all its attendant excretion and secretion products and its needed nutrients and energy sources.

In yet another preferred form of the invention, various inhibitors and/or stimulators may be added to the incubation medium to affect the metabolism of the microorganism and/or exhibit additional effects on the mechanisms involved in directing and controlling and impacting the formation, chemistry, and properties of the nanophase material that is produced. For example, sodium azide at 0.1-1 μmol/ml or cyanide at 1-5 μmol/ml may be used to inhibit growth of Desulfovibrio while stimulating the rate of sulfate reduction in H₂. Either chemical may therefore be used to affect the properties of the nanophase sulfide that is formed by SRB production and release of sulfide. The sulfate ion has several structural analogues and, of these, the selenate and monofluorophosphate ions are known to be powerful and specific competitive inhibitors of sulfate reduction, though not of the reduction of ions such as sulfite or thiosulfate. Selenate and/or monofluorophosphate may therefore be used in an incubation medium containing sulfate and sulfite and/or thiosulfate to enable the production of sulfide via sulfite and/or thiosulfate reduction while permitting sulfate levels to remain constant. In hydrogen, sulfate reduction by cell suspensions may be strongly inhibited by arsenite; sulfite and thiosulfate reduction were intermediate in sensitivity. Arsenite may therefore be used in incubations with hydrogen to control the ratios of various sulfur sources utilized in extracellular precipitate formation and thereby affect the properties of the sulfides that are produced. Azide, hydroxylamine and tungstate are other examples of inhibitors that may be used in accordance with the present invention. Methyl and benzyl viologens strongly inhibit sulfate reduction by resting cells; thiosulfate and sulfite reduction are not so influenced. Such inhibitors, therefore, may be used to produce precipitates formed via redox transformations only, even in the presence of sulfate, without the formation of sulfides.

Salts used to poise the redox potential can be incorporated into the microbially-produced precipitate and strongly impact its structure and activity; affect cell metabolism; or cause metal precipitation through abiotic mechanisms. Redox poising reagents that may be used to establish the necessary conditions for sulfide formation include but are not limited to, for example, H₂S, Na₂S, a thiol compound such as cysteine or sodium thioglycollate, titanium(III) citrate, and the like. A single redox poising reagent may also exhibit multiple effects. For example, titanium(III) citrate may affect the production of the sulfide nanophase material not only through establishing the redox potential, but also by serving as a nutrient.(i.e., citrate) for the microorganism which, in turn, affects its metabolism; by supplying metals (i.e., titanium) that may be incorporated into or interact with the precipitate as it is formed; and/or by as a chelating agent (i.e., citrate).

As with oxides, the choice of the initial pH and the means used to control pH during the incubation may also be manipulated and controlled to affect the formation of the desired nanophase sulfide material in accordance with the present invention; and may also affect the formation of the nanophase material via a variety of mechanisms. Common ‘pH buffers’, for example, can act as complexing agents that affect metal ion concentrations, their ability to precipitate, and/or their bioavailability; can reductively or oxidatively dissolve metal precipitates; can bind to metal precipitates and affect their surface properties; and can even serve as nutrients or, conversely, inhibit various enzymes or electron transport molecules. It has been shown, for example, that establishing an initial pH during the formation of an iron sulfide in such a way that some of the dissolved iron in an incubation medium is precipitated through chemical precipitation processes may have a striking impact on the resulting microbially-precipitated sulfides. Chemically precipitated iron species can take one of several forms and/or can change form, depending on the incubation conditions. For example, when the incubation medium was at neutral pH and the Eₕ poised to [symbol] 200 mV prior to inoculation with the microbes, some of the iron precipitated as white ferrous hydroxide, which rapidly changed to a relatively stable, complex, ferroso-ferric oxyhydroxide, a dark blue-green hexagonal material with an indefinite formula that contained a variable amount of ferric iron. The presence of these precipitated iron forms was subsequently shown to have a significant impact on the structures and properties of microbial iron sulfides, yielding precipitates that were completely different from those produced with alternative iron sources under otherwise identical incubation conditions. The other effects that pH can have may be much more subtle and unexpected. For example, soluble cytochrome c₃ from D. gigas can be obtained simply by washing the cells with a slightly alkaline buffer, without disrupting the cells. As will be discussed below, cytochrome c₃ plays a variety of roles in the metabolism and metal precipitation reactions of Desulfovibrio strains. Altering the cytochrome c₃ content of the cells by altering the pH, therefore, can not only limit or alter sulfide production (when sulfate is used as the substrate), but can also minimize or limit the incorporation of various metals into the precipitate through redox transformation mechanisms.

Various gases may also be used to affect and control the production of the desired nanophase material, in accordance with the present invention. For example, it is known that gaseous H₂ is involved in the carbon metabolism of Desulfovibrio at several stages. It can support sulfate reduction, and can be used as an energy source, which can be used to assimilate organic matter, and, hence, indirectly support growth. The role that H₂ may play in the metabolism of a given microorganism and, hence, in the microenvironment surrounding and the formation of the sulfide precipitate, may vary strikingly from the role it may play in another. It has been demonstrated with chemostat cultures of D. desulfuricans that these bacteria could simultaneously ferment excess pyruvate to hydrogen and carry out respiratory sulfate reduction with limiting sulfate. Addition of excess sulfate to these cultures caused either cessation of net hydrogen accumulation or reuptake of hydrogen. Similarly, with batch cultures of D. vulgaris, there was net hydrogen evolution during early stages of growth followed by rapid uptake. Hydrogen sulfide did not begin to accumulate appreciably until the hydrogen uptake phase commenced. Cultures that had been sparged with argon in order to continuously remove hydrogen grew very poorly. Additionally, two types of membrane-bound hydrogenase, a high-molecular-weight and a low-molecular-weight species, were found to correlate with hydrogen evolution and uptake respectively. Hydrogen was found to completely inhibit lactate oxidation in D. gigas cultures, yet had no apparent effect on lactate metabolism in D. vulgaris Hildenborough cultures. Only low levels of hydrogen are usually found in cultures of Desulfovibrio, but almost 0.5 mol H₂/mol lactate metabolized could be detected in the culture headspace of D. vulgaris Hildenborough. However, sulfide did not begin to accumulate until hydrogen evolution had reached its final stages. Heterotrophic growth of D. gigas is completely suppressed by an atmosphere of hydrogen.

Carbon dioxide is another gas that may have an impact on the formation of a sulfide precipitate and, hence, on the properties of the nanocatalyst, although for entirely different reasons. Purging with CO₂ may, for example, increase the evaporation of H₂S, thereby decreasing the bulk sulfide concentration, increasing alkalinity, plus causing the incorporation of carbonate-containing materials in the sulfide precipitate. High salt content in the medium may compete with metal ions in the interaction with the released sulfide and help tailor the reaction. It has now been found that, when SRBs are incubated in media that contain a high concentration of iron sulfate plus a high concentration of a mixture of heavy metals, certain heavy metals which do not form insoluble sulfides are incorporated into the sulfide precipitate. It has believed, although not conclusively demonstrated, that this carbonate interaction may one the mechanism whereby such metals are incorporated; and that this mechanism, especially with CO₂ control, may be used to incorporate carbonate-based “minerals” into nanophase precipitates.

Oxygen, for example, may effect irreversible and reversible inactivations of hydrogenases. Hence, prior exposure to oxygen can have a significant impact on precipitate formation by SRBs via both the sulfide and redox routes.

It will be apparent to those versed in the art, then, that the role that virtually any chemical present during incubation can play in the production of catalysts, nanocatalysts, and other nanophase materials in accordance with the present invention is extremely complicated. The many and varied mechanisms whereby the properties of the nanophase material are affected have not been fully elucidated; nevertheless, the fact that the constituents have such effects is now known, and that the constituents must be carefully controlled has been established. The present invention is not limited by theory, and is not to be limited solely because the underlying phenomena have not been fully characterized or identified, or limited to the examples provided herein.

For the purposes of the present invention, incubation parameters that may be altered or adjusted to cause the formation of a given nanophase material with desirable properties are not limited to the constituents of the incubation medium itself, but may also include such parameters as temperature, pressure, light (including both the intensity and the wavelengths thereof), and the like. These parameters may enable the utilization of microorganisms that would otherwise be unable to grow and/or produce inorganic precipitates, and/or may affect or alter various metabolic processes in the microorganisms and/or the bulk medium surrounding them and thereby affect the chemistry and properties of the extracellular nanophase material that is produced.

For example, since SRBs have been isolated from environments with temperature, pressure, and salinity extremes, such microorganisms may be very useful in producing unusual nanophase sulfide materials. SRBs can be grown at pressures ranging from incubation in vacuo to incubation in water at 1×10⁵ kPa hydrostatic pressure. It has been pointed out that probably more SRBs in nature function below 5° C. than above, because of their abundance on the ocean beds; by the same reasoning, probably more SRBs function at high pressures than at atmospheric pressure. Pressure may therefore be one parameter used to control or alter the properties of a sulfide nanocatalyst or nanophase material produced in accordance with this invention.

Light (i.e., the absence thereof as well as the presence and/or the wavelengths of irradiation) may also have an impact, through more than one mechanism. For example, it may be possible to increase the range of microorganisms that are used to produce sulfide nanophase materials in accordance with the present invention and, hence, the range of chemistries and properties of nanophase materials that can be produced through the use of this invention, by controlling the amount of light that a culture of organisms receives. For example, when the green alga Cyanidium caldarium; is grown in the dark, anaerobically, a membrane associated sulfate reductase system functions, producing H₂S. In yet another preferred form of the invention, the alga may be incubated anaerobically in highly acidic media (pH 1-4) to produce extracellular sulfides containing metals such as iron, copper, nickel, aluminum, and chromium, for example. Further, many of the nanophase materials that may be produced in accordance with the present invention are semiconductor materials. For a number of years researchers have been interested in the use of semiconductor materials to perform photocatalytic reactions such as solar detoxification (i.e., the removal of organic contaminants from water), and the production of new forms of environmentally benign fuels. The requirement for such a process includes high quantum efficiency for generation of hole-electron pairs under solar illumination, low rate of recombination of these pairs once formed, and a high efficiency for transfer of the electrons and holes to the chemical reactants. The most commonly used material, TiO₂, has too wide a band-gap (^{˜}3.1 eV, ^{˜}400 nm absorbance onset), to efficiently generate hole-electron pairs using sunlight. Also, the TiO₂ powders typically available are large in size, which increases the rate of recombination. The probability for trapping at defect sites on the cluster surface is increased considerably when the total number of surface sites is large (e.g., for nanosize powders). Bulk pyrite (FeS₂) and MoS₂ are infrared (IR) semiconductors, and therefore cannot use solar irradiation for photocatalysis. The semiconductor FeS₂ in colloidal form, however, has been proposed for many solar-based photocatalysts applications. The band-gaps of colloidal pyrite FeS₂, CdS, and MoS₂ shift to the visible region when these semiconductors are made in nanosize form. At the same time, their small size reduces light scattering which interferes with the generation of exciton pairs throughout the entire dispersion. It has been shown that 3.5-4.5 nm sized FeS₂ has nearly the ideal absorbance characteristics to match the solar spectrum. Other studies have shown that organics such as acetate react in the presence of sunlight to methylate conventional mercuric sulfide precipitates. Therefore, irradiation may induce photocatalytic behavior in microbially-produced nanophase semiconductor materials, thereby causing interactions with constituents in the incubation medium or even interactions between the microbial reagent and the nanophase material it is producing.

It should be noted that the present invention is not limited to the incubation of the microbial reagent in an aqueous medium. Rather, the microorganism may be incubated in a nonaqueous medium to produce yet other unique, unusual, and/or desirable nanophase materials. For example, it has long been known that SRBs are associated with many aspects of oil technology, although their exact role(s) remains undefined. One preferred form of the invention for producing novel nanophase sulfides is to culture SRBs in nonaqueous liquid media, especially nonpolar media. Alternatively, the microbial reagent may be grown in a semi-solid medium, such as agar (as is discussed elsewhere), or even in a gaseous medium while being exposed to various substrates needed to produce the precipitate in vapor or liquid aerosol or other minimally liquid form. SRBs have even been shown to grow in vacuo; production of the nanophase material under reduced pressure in the presence of a controlled stream of vapor or liquid aerosol, perhaps in the presence of gaseous H₂, may result in the formation of unusual nanophase materials, for example.

In yet another preferred form of the invention, microbially-mediated, cell-free nanophase material production may be performed by providing a nucleation surface that is separated from the microbial culture by a semi-permeable membrane through which the inorganic ions can diffuse.

It might be expected that the only inorganic ions such as metal ions that would be incorporated into a sulfide precipitate would be those that form an insoluble sulfide. However, it has now been found that metal ions that do not form insoluble sulfides can be incorporated into the nanophase material in a single incubation step in accordance with the present invention. For example, a Desulfovibrio strain was incubated in various mixtures containing ions that form insoluble sulfides, such as Fe, Ag, Hg, Pb, Cu, Zn, Sb, Mn, Fe, As, Ni, Sn, and/or Al, as well as ions that do not, such as Rh, Au, Ru, Pd, Os, Pt, and Cr. Nanophase materials comprising all of these elements and/or various mixtures thereof were produced. In addition, it has also been shown that other inorganics such as Mg and Si may be incorporated into nanophase sulfides during incubation in a solution containing mixtures of inorganic ions. Although the present invention is riot bounded by theory, it is believed that various phenomena may be utilized to induce the incorporation of desired inorganic species into nanophase materials. For example, an examination of the data showed the incorporation of certain inorganic species may depended to some extent upon the relative proportions of the species in the incubation solutions, as well as the pH. The ability to incorporate magnesium into some of the nanophase sulfides prepared in accordance with the present invention appeared to be strongly dependent upon the presence of aluminum, for example; when little aluminum was in the sample, no magnesium was taken up, but when large quantities of aluminum were present (15,200 mg Al/L), not only was the aluminum entirely incorporated, but so was >90% of the Mg from an original concentration of ^{˜}14,150 ppm Mg. It is well known that aluminum will form various minerals with a wide range of inorganic materials. Alternatively, it has been shown that various inorganic species will chemisorb onto microbially-produced precipitates.

It should be noted that the use of SRBs is not limited to the production of nanophase sulfides in accordance with the present invention. SRBs and related microorganisms may be used to produce other types of inorganic precipitates or even mixtures or layers of non-sulfide and sulfide-free nanophase materials. For example, as mentioned elsewhere, most Desulfotomaculum spp. and some Desulfovibrio spp. can grow without any reducible sulfur compound if an appropriate carbon source is available, including, for example, pyruvate, choline, malate, or fumarate. In addition, some strains can reduce nitrite to ammonia. In yet another preferred form of the invention, therefore, such microorganisms may be incubated in media containing such nutrients and appropriate inorganic substrates to produce non-sulfide nanophase materials, e.g., through direct redox transformation of inorganic ions such as hexavalent chromium or uranium, pertechnetate, and/or Au(III).

### EXAMPLE 3

### Production of Other Nanophase Materials

In yet another example of the present invention, microorganisms are used to produce nanophase phosphate materials. In this particular example, the nanophase phosphates are produced by incubating a suitable microorganism in a solution containing a suitable organophosphate and one or more metal ions. The organophosphates that may be used include but are not limited to, for example, monoalkyl, dialkyl, trialkyl, and aryl phosphates, e.g., dimethyl phosphate or tributyl phosphate; phosphoramidic acids, O-phosphorothioates, and inorganic triphosphate; and the like. The inorganics that may be precipitated include but are not limited to, for example, Ba, As, Cr, Cd, Zn, Pb, Ni, U, Sr, Ru, Co, Cs, Ce, and Zr, and the like. For example, a Citrobacter sp. may be incubated in a solution containing glycerol 2-phosphate and Cd or U to produce nanophase CdHPO₄ and UO₂HPO₄. This microorganism may be incubated in solutions containing other metal ions, such as lead, to produce other extracellular nanophase phosphate materials. If desired, a different microorganism may be used to produce different materials; for example, the bacterium Bacillus subtilis or the yeast Candida utilis may be incubated in a ferrous ammonium sulfate and uranyl acetate solution containing glycerophosphate to produce nanophase uranium phosphate materials. When incubated under the appropriate conditions, such organisms may produce as much as 4-5 times their own wet weight in phosphate precipitates within two hours. These same two microorganisms may also be incubated in a solution containing U, Ru, Sr, Co, Cs, Ce, and/or Zr to produce the respective nanophase metal or mixed metal phosphates. B. subtilis or C. utilis may be grown in glycerophosphate, and subsequently incubated in solutions containing 11 ppm each of to produce an extracellular phosphate precipitate containing all of said ions.

As with the production of nanophase oxide and sulfide, a variety of techniques may be used to modify the nanophase phosphate precipitate that is produced. For example, the combination of the microorganism and organophosphate that is used [symbol] and, hence, the monoesterases, diesterases, and/or triesterases that will be involved in the production process [symbol] may be altered to yield different nanophase materials. Similarly, the pH of the incubation medium may have an impact on whether acid or alkaline phosphatases are involved in the extracellular precipitate formation. Some phosphatases are relatively specific with regard to which organophosphates can serve as substrates, while others are relatively nonspecific. Inhibitors may also be used to control the phosphatases that form and release the phosphate ions. For example, the sensitivity of these phosphatases to poisoning by heavy metals varies. Hence, a particular phosphatase may be prevented from participating in the production of a nanophase phosphate either by the selection of the organophosphate substrate, or by the use of heavy metal inhibitors. For example, it has been found that with a Citrobacter sp., Mn²⁺ stimulated diesterase activity but did not affect monoesterase activity. Another type of phosphatase which exhibits high activity for pyrophosphate is inhibited by fluoride, molybdate and orthophosphate.

It should be noted that actively growing cells are not required for the production of nanophase materials such as nanocatalysts in accordance with the present invention. For example, it has been shown that resting cells may be used instead of actively growing cells, which may be used to modify the microenvironment in which the nanophase material is produced. For example, a Citrobacter sp. was stored in saline for seven days at 4° C. and subsequently incubated in a glycerol 2-phosphate solution containing Cd at pH 7.5 to produce an extracellular cadmium phosphate precipitate. It was established that the treatment of the cells prior to cadmium exposure affected the rate at which the cells produce the precipitate (e.g., under the conditions cited herein, the resting cells increased their production of Cd phosphate precipitate by more than 55% by comparison with actively growing cells) and hence the precipitate that is formed.

The choice of microorganism may play an important role in the production of cell-free nanophase materials. With certain types of microbes, it has now been shown that the extracellular precipitate will “cling” to the surface of the microbe and will remain attached to it. With other microbes, however, the precipitate remains “free” of the cells and can therefore be readily separated from them. For example, studies with Escherichia coli showed that although E. coli effectively precipitated uranium in extracellular colloids, the material did not adhere to the cell wall. Although the present invention is not bounded by theory, it was hypothesized that E. coli is lipophilic, while some of the other strains studied, which did become coated with metal precipitate, are hydrophilic, i.e., hydrophilic cell surfaces may be necessary in the formation and preparation of certain nanophase materials, while hydrophobic surfaces may be preferable for the production of others. Hence, if complete separation of the cellular material and the nanophase material is important, a lipophilic microorganism may be used.

In yet other preferred forms of the invention, germanium or silica or mixed precipitates may be produced. Diatoms may be incubated in germanic acid or a mixture of germanic acid and silicic acid to produce an extracellular nanophase germanium or germanium-silicon material, for example. Alternatively, B. subtilis may also be used to produce extracellular silica microcrystallites. In yet another example, bacteria may be incubated in suitable media to produce nanophase Fe—Al limonitic clays. It is apparent that many other microorganisms may be used in the extracellular production of many different nanophase materials including many different nanocatalysts.

The present invention is not limited to the foregoing examples but covers, rather, the use of microorganisms to produce inorganic catalysts, nanocatalysts, and other nanophase materials whether of (hydr)oxide, sulfide, phosphate, or sulfate composition, silicate or carbonate composition, metal or metalloid composition, a mixture thereof, or of some other composition produced by microbially-mediated extracellular precipitation. It is apparent that many other microorganisms may be used in the extracellular production of many different nanophase materials including many different nanocatalysts.

### EXAMPLE 4

### Preparation of Microbial Reagents

A microbial reagent that is to be used in the production of nanophase materials in accordance with the present invention may be prepared simply by being cultured and grown through the use of conventional techniques such as are well known by those versed in the art. Alternatively, the microorganism may be chemically modified, manipulated, or otherwise altered so,that its chemistry is altered and, thus, the chemistry and properties of the nanophase extracellular precipitate are altered or the production is improved or enhanced. The techniques that may be used to prepare the microbial reagent may include but are not limited to, for example, genetic engineering of key proteins or other cellular constituents; stressing or osmotic shock or pregrowth in appropriate media to cause overproduction or release of enzymes; chemical treatments to alter cell permeability; treatments or manipulations to cause elimination, removal, inhibition, or substitution of one or more biological macromolecules or metabolic pathways involved with metal precipitation and/or macromolecules or pathways capable of influencing cellular metabolism, the internal chemical milieu, and/or the microenvironment immediately surrounding the cell; and the like.

Genetic engineering of the proteins involved in metal precipitation is one technique that can be used in accordance with the present invention. In the case of the SG [symbol] 1 spores for example, it has been shown that the metal precipitates are formed by a surface protein that directly interacts with and oxidizes various metals. The genes that encode for this protein have been identified, and various mutants developed. By altering the genes that encode for this protein, using genetic engineering techniques such as are known to those versed in the art, to produce a protein with altered affinity and/or specificity for metals, the nanophase oxides that are produced by the spore reagent can be altered or tailored.

Alternatively, other techniques may be used to alter the biological macromolecules that are involved in the formation of the extracellular precipitates and/or alter the microenvironment immediately surrounding the microorganism and thus the chemistry of the forming precipitate. Many morphological types of bacteria are able to oxidize Mn²⁺ enzymatically; in some cases the oxidation is directly coupled to the cells' phosphorylation system responsible for energy. For example, a manganese oxidase system apparently catalyzes manganese oxidation in Leptothrix discophora with electrons conveyed to O₂ via cytochromes; the membrane-associated Mn-oxidizing activity as well as endogenous O₂ uptake were inhibited by cyanide, azide, and o-phenanthroline, suggesting that cytochromes or other metalloenzymes were involved. Because cytochromes are biological macromolecules that generally have extremely low redox potentials, the formation of a given nanophase material may be controlled, at least in part, by controlling not only which enzymes are involved in the process, but also which electron acceptors are involved; i.e., through the judicious selection of nutrients, reversible or irreversible inhibitors of cytochromes and/or associated enzymes, etc., one or more elements in a given metabolic pathway may be either induced or inhibited, thereby affecting the pathway(s) that are involved in metal ion binding and oxidation and, hence, the microenvironment(s) under which the nanophase materials are formed.

Treating microorganisms with a quaternary detergent such as cetyltrimethylammonium bromide can be used to make the cells freely permeable to diffusible compounds. Although the present invention is not bound by theory, it is believed that such a treatment may affect the formation of the nanophase material through mechanisms such as, for example, increasing the increasing the rate and/or number of nutrients, substrates, inhibitors, and the like that can diffuse quickly into the cell; upsetting natural proton gradients; “decompartmentalizing” enzyme systems (e.g., making electron transport molecules associated with one enzyme complex accessible to others); and the like. Such treatments may also be used to insert new electron acceptors, including synthetic electron acceptors, to affect the formation of extracellular precipitates.

It is known that in spite of their striking physiological and morphological differences, all strains of SRBs are equipped with a common mechanism for utilizing sulfate (or thiosulfate) as the terminal electron acceptor, with only a few minor variations among the many different species. The mechanism consists of three major enzymes, i.e., ATP sulfurylase, adenylylsulfate reductase, and bisulfite reductase. In addition, it has been demonstrated that the 8 electron pairs necessary to reduce sulfate into hydrogen sulfide necessitate the presence of a sophisticated set of electron carriers such as c-type cytochromes and/or non haem iron proteins. The microbes produce the sulfide at, near, or within the cell surface in the periplasmic space. Depending on the individual species, the enzymes may or may not be membrane-bound, although the sulfate-reducing system itself seems to be membrane-associated in most species. It is also known that the sulfide ion produced and released by unrelated microbes, such as anaerobically-grown green algae, is due to the activity of a similar, membrane-associated sulfate reductase system.

Studies on the structure of the electron-transfer components of the sulfate reduction system in SRBs are far more advanced than studies on function. This is due in part to the fact that some electron-transfer proteins exhibit an apparent lack of specificity (i.e., in most reactions flavodoxin can substitute for ferredoxin) and in part to the fact that many of these proteins appear to be compartmentalized. Thus, when extracts are prepared, enzymes and electron-transfer proteins from the periplasm, membranes, and cytoplasm are mixed, and physiological specificity afforded by their localization is lost. While this latter factor is a problem when trying to elucidate the function of the various components, it may serve as an additional parameter that can be altered or manipulated in preparing microbial reagents for the production of nanophase sulfides. For example, by altering the permeability of the cell membrane or by using cell extract fractions rather than using the whole, untreated organism, compartmentalization can be altered or eliminated, thereby permitting new routes to nanophase sulfide production.

Soluble cytochrome c₃ from D. gigas may be removed, for example, simply by washing the cells with a slightly alkaline buffer without disrupting the cells. Cytochrome c₃ appears to be a highly versatile molecule capable of donating or accepting 1-4 electrons and interacting with a variety of redox couples by modulation of its midpoint redox potentials. Because of effects of pH, it also has the potential for being involved in the generation of proton gradients, as has been postulated for cytochrome oxidase. Accordingly, removing part or all of the soluble cytochrome c₃ of a microbial D. gigas reagent prior to production of the sulfide can have a significant effect on the nanophase sulfide that is formed. This simple alkaline washing treatment may therefore be one preferred form of the invention for preparing the microbial reagent.

While the underlying sulfate reduction chain found in all sulfate-reducing microorganisms is essentially the same in that it consists of the same three enzymes plus electron transport molecules, it varies in that the precise nature of those enzymes and electron transport molecules can differ from species to species, sometimes rather dramatically. One of the most notable ways in which the components of the sulfate reduction system vary [symbol] and one which may have a major effect on the formation of the sulfide precipitate [symbol] is the redox potential of the electron transport molecules. One electron transport molecule may be replaced by another to create a new microbial reagent for use in the production of nanophase sulfides. For example, hydrogenase and cytochrome c₃ from D. gigas catalyze the biphasic reduction of elemental sulfur to sulfide without inactivation of the cytochrome, as occurs with the cytochrome c₃ from D. vulgaris. The isoelectric points of the cytochromes c₃ from D. vulgaris and D. gigas extremely different, 10.5 and 5.2 respectively. Cytochrome c₃ from D. vulgaris is immediately soluble. In yet another preferred form of the invention, the cytochrome c₃ from D. vulgaris is replaced with that from D. gigas, and thereby a new microbial reagent is produced that may yield new and different nanophase sulfide materials, in accordance with the present invention. Alternatively, a different type of cytochrome and/or a ferredoxin, flavodoxin, rubredoxin, monoheme cytochrome c₅₅₃, or other types of electron-transfer proteins or redox proteins may be substituted to affect and alter the chemistry of the microbial reagent and, thus, the chemistry and properties of the nanophase sulfide.

Alternatively, D. vulgaris may be treated with sufficient quaternary detergent (cetyltrimethylammonium bromide) to make them freely permeable to diffusible compounds and subsequently incubated in media containing reduced phenol-indoldichlorophenol, Janus green or sodium indigodisulfate. The products of sulfite reductases are often different according to the electron carrier present; with methyl viologen, sulfide is often formed whereas a natural transporter might yield largely trithionate. Thiosulfate can also be formed, and is reduced by extracts of Desulfovibrio; so are the tetrathionate and dithionite ions. By altering cell permeability and incubating the microbial reagent in media containing synthetic electron carriers (including but not limited to, for example, methyl viologen, phenol-indoldichlorophenol, Janus green, or sodium indigodisulfate), the synthetic electron carriers may therefore be inserted and thereby made to take part in sulfide production and affect sulfide precipitate formation.

Hydrogenases in Desulfovibrio may interact with either cytochrome c₃ or with ferredoxin. As with cytochrome, ferredoxins found in Desulfovibrio can vary dramatically from species to species. For example, D. gigas has two different ferredoxins, identified as ferredoxin I and ferredoxin II. Ferredoxin I clearly contains a ferredoxin-type (Fe₄S₄) cluster and has a low redox potential (E^{o}′= [symbol] 440 mV). The ferredoxin II was demonstrated to contain three iron atoms per monomeric subunit and to have a much higher redox potential ( [symbol] 130 mV). While ferredoxin is definitely a soluble cytoplasmic protein in D. vulgaris, it is not clear whether this is true of D. gigas. If ferredoxin is membrane bound in D. gigas, for example, then the influence of cytochrome c₃ on the role of hydrogenases in the production of sulfide may be eliminated through using cellular particles rather than using whole cells, or through altering the permeability of the cell such that the cytochrome can diffuse out (e.g., by washing in alkaline buffer as described above).

Proton gradients are known to exist in some SRBs. Disruption of the membrane may change the proton gradient, with a resulting change in the microenvironment of the growing nanophase precipitate. Similarly, toluene may be used to alter the membrane properties of a Citrobacter sp. reagent prior to its use in the production of an extracellular nanophase metal phosphate.

In yet another preferred form of the invention, the microbial reagent may be prepared by stressing the cells to induce loss or overproduction of enzymes. Stressing microorganisms through exposure to, for example, high ion concentrations (i.e., osmotic shock) can cause a variety of responses which may be useful in manipulating the formation of a given nanocatalyst or other nanophase material, in accordance with the present invention. For example, a striking feature of the carbon metabolism of Desulfovibrio is the involvement of gaseous H₂ at several stages, including pyruvic phosphoroclasm, formate dismutation, and stimulation of the hydrogen sulfate reaction by organic intermediates. This hydrogen metabolism is mediated by a reversible hydrogenase present in most strains of SRB. It is believed that the hydrogenase assists uptake of that H₂ as it is formed and its use by Desulfovibrio as an energy source. Hydrogenase in D. gigas is readily released by osmotic shock. By exposing D. gigas to osmotic shock, the organism's metabolism may therefore be shifted dramatically (at least, during the time it would take to resynthesize the lost enzyme); and this shift may therefore have a major impact on the microenvironment that affects the formation of the sulfide precipitate.

Similarly, osmotic shock may be used to reduce the amount of acid phosphatases present in E. coli, when said microorganism is used to produce an extracellular phosphate material.

In yet another preferred form of the invention, the microbial reagent is prepared by pre-growth in a nutrient solution that induces the formation of one or more enzymes in quantity, or inhibits various enzymes. For example, the carbon source content of the medium influences the phosphatase activity of Klebsiella aerogenes and Bacillus subtilis. Inorganic phosphate may also affect the production of phosphatases, e.g., in E. coli. Alternatively, a technique for the enrichment of phosphatase-overproducing mutants, such as Cu-stressing, may be used instead. In yet another example, when glucose was used for 8 hours as the pre-growth carbon source for the Citrobacter sp. (doubling time 3 h), subsequent metal phosphate precipitate formation by the resting cells occurred during a sharp and distinct period, with very little metal uptake into the precipitate occurring either before or after this period. However, when glycerol was used as the pre-growth medium, the metal was taken up at a continuous rate by the resting cells.

Some metals are toxic, or even lethal, to various microorganisms, making it difficult to use higher metal concentrations in the production of desired nanophase materials. However, various mechanisms may be used to alter the metal concentration that can be used in the production of nanophase metal precipitates. Yet another approach to preparing the microbial reagent is to pre-grow the microorganism in the presence or absence of one or more heavy metals. For example, Citrobacter cells pre-grown in cadmium-free medium and then used in the nongrowing (resting) state during nanophase phosphate production may be incubated in solutions containing higher cadmium concentrations than may be used if the cells are not pre-grown and/or are used in the actively growing state. Alternatively, pregrowth under conditions that induce the overproduction of phosphatase may be used to increase cell resistance to Cd²⁺ toxicity and to enhance Cd phosphate precipitate formation, in accordance with the present invention.

It should be noted that the present invention is not limited to the use of a single or isolated strain of microorganism; but that mixed cultures may be used in the production of nanophase materials as well, and may be useful in the production of nanophase materials that cannot be produced readily by isolated strains. For example, SRBs are notoriously difficult to isolate and work with as pure cultures, presumably because they often exist in mutually beneficial symbiotic relationships with other types of microorganisms, e.g., methanogens. This invention is based on the conception that microorganisms create and control microenvironments within and immediately surrounding their individual cells that affect the chemical reactions occurring within and immediately surrounding their cells. A mixed culture, then, may be preferable for creating microenvironments that a single type of cell might be unable to create and, hence, may be useful in producing unique catalysts, nanocatalysts, and other nanophase materials in accordance with the present invention.

For example, one reason that SRB growth is often slow is that H₂S decreases the growth rate and can, at high concentration, slow the growth rate to zero. By growing the sulfide producers in a mixed culture containing microorganisms capable of removing the sulfides, excess H₂S can be eliminated as it diffuses away from the site where the extracellular inorganic precipitate is forming, thereby controlling the H₂S concentration. One method of enrichment for Desulfuromonas species, for example, is co-culture with the marine green sulfur bacterium Prosthecochloris aestuaril. The latter provides elemental sulfur as a terminal electron acceptor to the Desulfuromonas, and also prevents the accumulation of inhibitory concentrations of sulfide by the removal of H₂S produced by Desulfuromonas. Such co-culture techniques may therefore be used in accordance with the present invention to enable the utilization of Desulfuromonas in the efficient production of sulfide nanophase materials.

The build-up of acetate may also otherwise be a problem during the production of sulfide nanophase catalysts or other nanophase materials in accordance with the present invention, since many SRBs produce acetate and CO₂ as the end products of metabolism. Acetate-utilizing methanogenic anaerobes may used to remove acetate if the sulfide concentration is low, e.g., if most of the sulfide released by the SRBs is quickly taken up by the forming nanophase precipitate. Such a co-culture may minimize not only the impact of acetate on the SRB metabolism, but also its chemical interactions with metal ions in solution and with the inorganic precipitate, and thereby affect and alter the chemistry and composition of the nanophase material that is produced in accordance with the present invention. Alternatively (or in addition), an SRB such as Desulfotomaculum acetoxidans, which can also oxidize acetate, or another sulfide-tolerant microorganism such as Desulfuromonas acetoxidans, an anaerobic acetate oxidizer, may be used. D. acetoxidans is not a sulfate-reducing bacterium; it reduces elemental sulfur to H₂S while oxidizing acetate to CO₂.

Note that a mixture of different sulfide-producing microorganisms, however, might be expected to produce a mixture of nanophase materials rather than a controlled production of a single, mixed-metal or layered catalyst, nanocatalyst, or other nanophase material, unless only one type of microbe possessed a suitable cell surface for serving as a nucleation site (as is discussed elsewhere).

### EXAMPLE 5

### The Production of Nanophase Materials by Microbial Derivatives

It should be noted that the present invention is not restricted to the use of viable organisms for the production of the nanophase materials; nonviable microorganisms and/or preparations made from microorganisms (i.e., “microbial derivatives”) may be used instead. For example, it has been shown that the SG [symbol] 1 spores cited above, when rendered nonviable (incapable of germinating) by a variety of techniques including UV irradiation and chemical treatment (e.g., with glutaraldehyde) are capable of producing new and unusual nanophase Mn(III,IV) oxides and manganates, as well as iron, zinc, and cobalt materials and mixtures thereof, by incubation in dilute metal ion solutions.

Alternatively, certain nanophase metal oxide materials may be produced through the exploitation of cellular components, rather than the use of the entire cell. Isolation of cellular components can affect the nanophase material that is formed through a variety of mechanisms, e.g., through decoupling the cellular components that are involved in the formation of a given nanophase material from other cellular components; through separating the growing nanophase precipitate from the nucleation sites on the surface of the microbial cell and, hence, forcing the nucleation to take place on a different surface with different properties, altering the microenvironment in which the precipitate is forming, etc. The nonviable microbial derivatives may be formed by any of a variety of means such as those known to those versed in the art. For example, freeze drying may be used to preserve stock cultures, providing the drying menstruum is protective. Air, vacuum or acetone drying without protection disrupts the organisms and can be used for obtaining enzymically active cell preparations. It has been shown that cell extracts of Oceanospirillum sp. and Vibrio sp. exhibit Mn-oxidizing activity in the presence of MnO₂ provided that the extracts contained both the particulate fraction containing the cell membranes, and a heat-stable soluble periplasmic factor.

For some applications, it may be preferable to produce a nanophase material that is completely separated from all biological materials such as the cell envelope. This may be accomplished with microbial derivatives as well as with viable microbes. For example, it has been shown that Leptothrix sp. grown in agar gels containing Mn²⁺ form Mn-oxide precipitate particles that appear to be similar, when examined by microscopy and acridine orange staining, to the fungal nanophase particles described earlier. It is believed that Mn-oxidizing factors are produced and excreted by the fungi or Leptothrix sp., and diffuse into the agar or in starch polymers, where they oxidize the metal and thereby produce these nanophase particles.

Similarly, nanophase sulfide materials may be produced in accordance with the present invention through the use of microbial derivatives. Nonviable biomass consisting of whole cells, or of whole cells with modified membranes, may be used; alternatively, subcellular organelles or components may be preferable for the production of a given nanophase material. When using whole cell biomass to produce the sulfide precipitate, it may be preferable, although not necessary, to disrupt the cell in preparing the biomass, to minimize the time required for substrates or reaction products to diffuse through the cell membrane or wall. Since some of the components of the microbial sulfate-reducing system are not membrane bound in some species, however, it may not be advisable to completely rupture the cell membrane. Instead, the permeability of the membrane or cell wall may be increased by procedures that are known to those versed in the art, e.g., through the use of quaternary detergents. Freezing suspensions of SRBs in physiological saline or dilute phosphate buffer is one way of obtaining microbial derivative preparations; air, vacuum or acetone drying without protection may also be used, as may other conventional methods of disrupting bacteria including but not limited to, for example, grinding, decompression and treatment with ultrasonic sound. For example, the sulfite reductase system (i.e., the enzyme complex which yields sulfide from sulfite) is often associated with subcellular particles. It has been shown that particles from D. gigas incubated with sulfite and dissolved H₂, may be used to produce sulfide precipitates.

### EXAMPLE 6

### Post-Treatments to Modify Nanophase Materials

The nanophase materials produced by the simple, two-step microbial incubation processes described above may or may not possess precisely the chemical and physical properties that are desired for a given product or application. It may be that one or more additional steps, i.e., post-treatments, are needed to produce the optimum nanophase material in accordance with the present invention. Many different post-treatments, all of which are simple and inexpensive, may be used to tailor or modify or optimize the microbially-produced nanophase material in accordance with the present invention. These include but are not limited to, for example, secondary microbial/biochemical, chemical (liquid or gas), thermal, pressure, irradiation, drying and/or separation post-treatments, and the like. A few examples of the many different types of post-treatments that may be used to tailor or modify or optimize the nanophase materials produced in accordance with the present invention are presented below. It will be apparent that many other simple post-treatments may also be used, if desired.

Numerous researchers have found that bimetallic inorganic catalysts can offer superior performance for some heterogeneous catalytic processes. Other studies have shown that a trace dopant can completely alter the mechanisms whereby a catalyst interacts with organics such as coal powders. For example, oxides that contain mixtures or layers of different metals can be highly preferable to “pure” oxides for many applications, especially for many nanocatalyst applications. Several different approaches are possible with the present invention for producing mixed oxides, hydroxides, oxyhydroxides, manganates, and even oxides mixed with phosphates, sulfates, carbonates, and the like. Incubation of the microorganism in a mixture of metal ions is one way to produce unusual or desirable nanophase materials containing mixtures of metal precipitates. It has been shown, for example, that when the marine Bacillus SG [symbol] 1 spores are incubated in mixtures containing manganese, iron, cobalt, zinc, nickel, copper, and/or cadmium, various amounts of the various ions are all incorporated into the extracellular precipitate. It has also been shown, as was discussed earlier, that other inorganics such as Ca and Mg may also be incorporated into the nanophase material by incubation of a microorganism under suitable conditions.

It has now been found that a wide range of mechanisms may come into play in the formation of the extracellular metal precipitates under such conditions, including not only metal ion oxidation or reduction catalyzed by a variety of different proteins, but also precipitation, co-precipitation, adsorption, absorption, chemisorption, intercalation, and possibly simple entrapment; and also oxidation and/or reduction of various metal species by the precipitate itself. This range of mechanisms may make it difficult to control the formation of the precise nanophase material that is desired if the microbial reagent or derivative is incubated a single time in a mixture containing all of the ions that are to be incorporated into the final product. In order to control the formation of mixed or layered precipitates of a specific composition and/or a more structured form, alternative approaches may be preferable. Other preferred forms of the invention, therefore, include the use of simple post-treatments to tailor or modify or improve a microbially-formed nanophase precipitate, such as the production of mixed or layered nanophase materials by incubating a single microorganism in a series of different solutions; incubating the nanophase material produced by the initial two-step microbial process using one microbial reagent in a suspension containing other microbial reagents that either add more inorganic constituents to the nanophase material or selectively remove some constituents; and/or incubating the microbially-produced nanophase material in solutions containing one or more additional inorganic species.

Various approaches for the use of microbial or biochemical post-treatments are possible in accordance with the present invention. In one preferred form of the invention, a single microbial preparation is subjected to a series of incubation steps to produce mixed or layered nanophase metal materials. For example, most cultures of Hyphomicrobium and Pedomicrobium deposit iron oxide, but only a few deposit manganese oxides; and the iron oxide deposition is apparently not linked to manganese-oxide deposition. Hence, it is possible to, for example, form an underlying iron oxide through a first incubation of these microorganisms in manganese-free media, followed by the formation of an overlying layer of manganese oxide by a second incubation in manganese-containing medium. Alternatively, a reversible inhibitor for the manganese oxidase can be used in accordance with the present invention to prevent the formation of manganese precipitates during the formation of the underlying iron oxide coating. After the initial incubation step, the reversible inhibitor is subsequently rinsed away and the metal(s) to be oxidized by the microbial enzyme are then added to enable the formation of the overlying layer(s). Other metals may be substituted for the iron and/or manganese, if desired, provided that the microbe's proteins are capable of binding and oxidizing other metals, such as the protein found in the marine Bacillus sp.

In another preferred form of the invention, mixed nanophase materials comprising, for example, sulfides and (hydr)oxides or phosphates and (hydr)oxides are produced by a single microorganism. In this form of the invention, the mixed nanophase material may be produced in a single incubation step, or in a series of two or more incubation steps. For example, D. desulfuricans is known to be capable of reducing U(VI) to insoluble U(IV), thereby bringing about uranium precipitation, and both D. desulfuricans and D. vulgaris are known to be capable of reducing Cr(VI) to Cr(III), resulting in the precipitation of chromium, by redox transformation mediated by cytochrome c₃. Hence, cytochrome-mediated redox transformation may be used to incorporate other ions into mixed-metal or layered nanophase sulfides, by incubating the microbes with these metals either before, during, or after incubation in mixtures containing sulfur substrates and other inorganic ions.

Similarly, microorganisms used to produce nanophase phosphates may produce nanophase materials by more than one mechanism and may therefore be used to produce mixed or layered nanophase materials in accordance with the present invention. For example, B. subtilis used to produce extracellular phosphates as described elsewhere, is a species representative of one of the best known and most widely occurring ferromanganese precipitating genera. Accordingly, oxides may be formed first by incubation in suitable solutions containing Mn, Fe, and/or other metal ions that are readily oxidized and precipitated; rinsed; and then incubated in phosphate media to add a layer of phosphates to the nanophase material; or phosphates could be formed first, and then coated with oxides.

In addition to SRBs, other microorganisms may be used in the production of nanophase sulfide materials such as nanocatalysts, including mixed-metal or layered nanophase sulfides. For example, Shewanella, unlike SRBs that are obligately anaerobic, are facultative anaerobes. Shewanella are capable of reducing thiosulfate and elemental sulfur to sulfide, and therefore capable of precipitating metal sulfides. Shewanella strains have been shown to be capable of direct enzymatic reduction of metal ions, such as reducing soluble U(VI) to insoluble U(IV), at the same time. Hence, Shewanella and similar microorganisms may be used in accordance with the present invention in the production of nanophase sulfides, mixed or layered sulfides, and sulfides mixed with (hydr)oxides by incubating the microorganisms with metal ions and sulfur substrate(s); and the mixed or layered nanophase materials may be formed by incubating the Shewanella with the sulfur substrate before, during, or after incubation with the metal ions that are incorporated into the nanophase material via direct redox transformation.

Alternatively, a series of two or more different microorganisms may be used to layer one type of precipitate on top of another in the production of a nanophase material such as a nanocatalyst in accordance with the present invention. For example, a variety of heterotrophic bacteria possess enzymes capable of mediating Mn oxidation on the surface of the MnO₂ particles. It has been shown that when Mn-oxidizing heterotrophic bacteria, including Arthrobacter sp., Oceanospirillum sp., and Vibrio sp., from deep-sea ferromanganese nodules and sediments are grown in rich media (e.g., Difco nutrient broth), the bacteria do not deposit Mn oxides in their colonies or around their cells. Instead, they accelerate Mn oxidation at the surface of preformed ferromanganese oxides or MnO₂ when these oxides are present. Hence, a nanophase oxide may first be formed by a given microbe under one set of incubation conditions; and a different metal oxide layer subsequently added through the use of that microbe [symbol] or another strain of microorganism [symbol] grown under another set of conditions in the presence of the original nanophase precipitate.

In yet another form of the invention, a microbial derivative may be used in a post-treatment to tailor a microbially-produced nanophase material. For example, the cell-free spent culture medium from the sheathed bacterium Leptothrix discophora contains a single manganese oxidizing protein. It has been shown that this protein has a high affinity for Mn²⁺ and that it catalyzes a rapid oxidation of Mn²⁺ to insoluble manganese oxide. Layered oxides/manganates may be produced by incubating a microbially-produced nanophase material, together with Mn²⁺ or other suitable metal ion(s), in this cell-free medium; the microbially-formed nanophase material provides the nucleation sites for the precipitation of the oxides formed by the protein in the post-treatment medium. Similarly, other excreted metal ion oxidizing factors from other microorganisms may be used to add the additional layer(s) in a post-treatment tailoring of a nanophase material.

In yet another preferred form of the invention, the post-treatment step may involve the removal of certain types or constituents of the nanophase materials once a mixed nanophase material has been produced. For example, bioleaching techniques may be used to selectively solubilize the unwanted precipitate constituent(s), either directly or through abiotic processes. As one example, Bacillus GJ33 may be used to selectively leach Mn, Co, Ni, and to some extent Cu from ferromanganese materials without significantly solubilizing the iron. The reason for the selective leaching in this instance is not clearly understood. Examples of microbially-mediated indirect selective leaching that may be used as post-treatments are the release of ferrous iron from iron oxide-containing materials such as limonite, goethite, or hematite or the release of manganous manganese from pyrolusite, vernadite, birnessite or todorokite.

Similarly, a mixed-metal sulfide may be formed and then subsequently incubated to remove certain elements via selective bioleaching techniques. It is known, for example, that acidophilic, chemolithotrophic bacteria may serve as agents for assisting the hydrometallurgical leaching of certain copper and uranium ores; and microbial cultures are used in ore beneficiation to remove certain ore components such as arsenopyrite from auriferous ores. Alternatively, some metals may be leached or solubilized by biogenic metabolites such as methyl iodide, which is known to be produced by many marine algae and fungi, or other biogenic transmethylation intermediaries such as methylcobalamin and trimethyltin. For example, some metal sulfides react with methyl iodide to yield soluble metal species, sometimes in their methylated forms. Similarly, organic acids and other metabolites produced by fungi may be used to solubilize metals from insoluble forms. Growth of these organisms either in the presence of the nanophase materials produced in accordance with the present invention or remote generation of biogenic solubilizing agents and subsequent treatment of the nanophase material in a flow stream may be used as a post-treatment to selectively remove certain components of the original sulfide. precipitate or other nanophase material. It should be noted that these post-treatments are merely examples of the many different techniques that may be used to further process the nanophase materials produced in accordance with the present invention, to tailor the nanophase materials' chemical and physical properties; and that many other chemical and biological post-treatments may be used instead of or in addition to these examples.

In another preferred form of the invention, a microbial preparation is used to treat or alter the nanophase precipitate through other mechanisms such as redox transformation. For example, D. vulgaris may be incubated with a Fe(III) oxide at circumneutral pH and dissolved H₂ to produce soluble Fe(II) and a highly magnetic iron oxide resembling, in that aspect, magnetite.

Alternatively, simple chemical post-treatments may be used to tailor or optimize the nanophase materials produced in accordance with the present invention. Although the adsorption of metals on synthetic oxides and ferromanganese nodules has been well studied, the adsorptive properties of microbially-produced oxides have not previously been characterized. It has now been found, by microscopic analysis and comparison, that microbially-produced oxides are excellent “adsorbents” for other metal ions, i.e., the microbially-produced oxides will take up large quantities of the other ions, both cations and anions, from solution. Although the phenomena involved in microbial oxide metal ion uptake have not yet been fully elucidated, and the present invention is not bound by theory, the inventor believes that preliminary studies indicate a wide variety of mechanisms may be involved, due to the unusual nature of the microbially-produced precipitates. These mechanisms may include adsorption, precipitation, co-precipitation, absorption, intercalation, and chemisorption, as well as oxidation or reduction and precipitation of various solvated metal species by the microbially-formed precipitate. Hence, a mixed metal or layered nanophase material such as a nanocatalyst may be readily and inexpensively produced in two simple incubations, in accordance with this invention. First, conditions are established such that a given “pure” or mixed precipitate is formed by incubation of a suitable microorganism under suitable controlled conditions in simple ion solutions or mixtures. Second, this microbially-produced precipitate is then removed from the initial incubation medium, rinsed, and subsequently incubated in a solution containing one or more additional metals. For example, it has been shown that the manganese and ferromanganese nanophase materials formed by the marine Bacillus spores, when subsequently incubated in solutions containing other ions such as Ni, Cu, Pb, Zn, Hg, As, Se, Ag, and Cd, take up these other ions and incorporate them into the precipitate. It will be apparent that many other ions may be used in addition to or instead of the Ni, Cu, and Cd. Similarly, nanophase iron oxyhydroxides may be incubated in solutions containing, and thereby doped with, cations and anions including but not limited to, for example, those of As, Se, Cd, Zn, Pb, Ag, Cr, Cu, Ni, U, Mo, Ra, and/or V.

Yet another mechanism that may be involved in the incorporation of multiple inorganics into nanophase materials produced in accordance with the present invention is the formation of surface alloys. It was recently discovered that pairs of incompatible elements that will not form bulk alloys can readily mix to form an alloy as long as the mixture is confined to a single layer of atoms on the surface of a crystal of one of the two metals (I Peterson, Chemical and Engineering News, page 53, Jan. 28, 1995). Since it has now been shown that nanophase inorganic materials produced in accordance with the present invention have exceptionally high surface areas, a far higher percentage of “incompatible” elements may be incorporated into the nanophase materials as surface alloys, through simple incubation of microbially-formed metal precipitates in suitable solutions containing metals.

In dilute aqueous solutions, Cr(VI) exists primarily as chromate (CrO₄² [symbol] ) and bichromate (HCrO₄ [symbol] ) anions. These ions are adsorbed by the surfaces of many oxide minerals, especially those with high values of the zero point of change, e.g., hydrous iron and aluminum oxides. Cr(VI) is also adsorbed by aluminosilicate minerals, such as montmorillonite and kaolinite, but more weakly. Chromate is a strong oxidant; for some applications, it may be preferable to modify a microbially-produced nanophase material by subsequent incorporation of chromate into the nanophase material through, e.g., incubation of a suitable nanophase oxide in a dilute aqueous solution of Cr(VI). Alternatively, it is known that phosphates may be sorbed on conventional hydroxylated metal precipitates by displacement of hydroxides (ion exchange). Hence, phosphate moieties may be incorporated into nanophase materials produced in accordance with the present invention by post-treating microbially-formed hydroxylated nanophase materials through incubation in phosphate-containing solutions. Similarly, sulfate may be sorbed on conventional hydroxylated metal precipitates by chemical bonding, usually at a pH less than 7. Sulfates are excellent oxidizing agents. Hence, the performance of nanocatalysts produced in accordance with the present invention may be enhanced for some applications through incubation in sulfate solutions under acidic conditions. Nitrate is sorbed on positively charged colloidal particles at a low pH; therefore, nitrate moieties may be incorporated into certain types of microbially-produced nanophase materials as well. More specific bonding mechanisms may be involved in the uptake and incorporation of fluoride, molybdate, selenate, selenite, arsenate, and arsenite anions; and these anions may similarly be incorporated into microbially-produced nanophase materials by simple incubation post-treatments.

Similarly, it has been shown that dopants can be incorporated as integral mixtures during initial sulfide precipitate formation, or added as layers after the support metal sulfide has been produced; and that very high loadings of the dopants can be achieved even when the original concentrations of the metal ions are low. Nanophase sulfides doped with a variety of inorganics may be produced by a simple incubation of a microbially-formed sulfide in a solution containing one or more of the desired inorganic(s). For example, the iron sulfide precipitate produced by incubating a Desulfovibrio sp. in modified Postgate's C at 32° C. may be modified by ‘doping’ with a heavy metal. The doping post-treatment may be accomplished by incubating the microbially-produced Fe_{0.7}S in a solution containing a cation such as Hg²⁺, Pb²⁺, Co²⁺, Cd²⁺, Ni²⁺, Cu²⁺, or Cr³⁺, for example. The initial concentration of the cation and the length of time the nanophase Fe_{0.7}S is incubated in the solution will determine the amount of dopant that is incorporated into the precipitate. It has been shown that very high dopant loadings may be achieved, e.g., at least in the range of 400-800 mg ion/g Fe_{0.7}S or higher, if desired. Under select circumstances (e.g., neutral pH and a very high ratio of dopant to sulfide) dopants such as Hg and Pb may be incorporated at much higher loadings, such as 2,000-3,550 mg dopant/g sulfide. Myriad studies with conventional inorganics indicate that adsorption of cations should be relatively low or nonexistent at neutral pH. Nevertheless, the microbially-synthesized iron sulfide quickly reduced the concentrations of the inorganic pollutants from 10 ppm to low-ppb levels at neutral pH while incorporating the dopants into the nanophase sulfide. Mercury, for example, was taken down as low as 2 ppb under the experimental conditions used, while Co and Pb were reduced to 60 ppb at pH=7.5. Evidence from EXAFS (extended X [symbol] ray absorption fine structure) indicated that chemisorption was a major metal ion uptake process for all of the ions tested except chromium. This last finding helps to explain why the residual metal ions can be taken to such low levels while the sulfide precipitate could be doped at such high loadings, and why doping may be accomplished at neutral or acidic pH. Hence, doping of the microbially-produced inorganics may be accomplished under very mild conditions and may be extremely efficient and therefore inexpensive.

It should be noted that the sulfide may be doped with inorganic materials that do not form insoluble sulfides, if desired. For example, the nanophase Fe_{0.7}S may be doped with a high loading of La³⁺, despite the fact that La³⁺ does not form an insoluble metal sulfide. In addition, the pH of the incubation medium may be adjusted to affect the amount of dopant incorporated and/or the form of the dopant when it is incorporated. Loadings of 240 mg La³⁺/g Fe_{0.7}S may be achieved by incubation in the range 1.4<pH<5, or at pH>9. Lower loadings may be achieved at more neutral pH.

It should be noted that simple chemical post-treatments may be performed by exposing the microbially-produced precipitate to gases as well as to liquid media. Sulfides may be further modified by exposure to oxygen or air, to accomplish partial or complete oxygen-sulfur exchange, for example. In one preferred form of the invention, for example, oxides are produced first by producing a nanophase sulfide such as the Fe_{0.7}S material produced by incubating the Desulfovibrio in modified Postgate's C, and subsequently exposing the microbially-formed sulfide to oxygen. The resulting nanophase material is an unusual nanophase iron oxide.

As discussed elsewhere, it may be desirable to produce a nanophase material that is free from cellular material. Some microbially-induced precipitation processes that may be used in accordance with the present invention will yield cell-free inorganics in and of themselves. However, it may not be possible to produce the desired nanophase material by such processes. An alternative is to produce extracellular precipitates that are initially associated with the microorganism and then, as a post-treatment step, separate the inorganic precipitate from the cell. This may be accomplished by techniques including but not limited to, for example, the use of a ‘French press,’ i.e., through forcing the microbial suspension through a suitable narrow orifice under pressure; other forms of pressure stripping; agitation or agitated stirring; tumbling or grinding of dried material; and like processes.

Yet another post-treatment that may be used to tailor or modify or optimize the chemical and physical properties of the nanophase material is a drying step. For example, the magnetic nanophase sulfide produced by incubating a mixed enrichment from marine sediments in lactate, sodium carbonate, and iron sulfate at pH 6.5 and 27° C., described above, may be modified by freeze-drying. Although the precise nature of the change in the chemistry and structure of the material has not yet been determined, it has been demonstrated that freeze-drying altered its chemistry. Before drying, the nanophase sulfide can be doped with a variety of different inorganics such as Ni, Mn, and Co by incubation in dilute ion solutions; however, after the microbially-produced sulfide has been freeze-dried, while it may be doped with various other ions, it does not readily take up Ni, Mn, or Co. Alternatively, a microbially-produced nanophase material may be modified by drying under anaerobic conditions. For example, another magnetic sulfide, when dried under air, gradually lost some of its magnetic properties; however, when dried under anaerobic conditions, the nanophase sulfide retained its magnetic properties even after repeated wetting and drying. Similarly, some 10 Å phyllomanganates of the buserite structure produced by the SG [symbol] 1 spores collapse to a 7 Å phase upon drying at room temperature.

Simple post-treatments such as aging may also be useful in preparing some nanophase materials with desirable properties. For example, a marine Bacillus species formed a nanophase material resembling hausmannite at higher temperatures (55°-70° C.). After aging (i.e., extended incubation in the Mn(II) solution), feitknechtite became the dominant or only nanophase material(s) present.

While the above detailed description of this invention and preferred forms thereof have been described, various modes of practicing this invention will be apparent to those skilled in the art based on the above detailed disclosure. These and other variations are deemed to come within the scope of the present invention. Accordingly, it is understood that the present invention is not limited to the detailed description.

1. A process for the reproducible preparation of inorganic nanophase materials, comprising the steps of:
preparing a microbial reagent which includes at least one microorganism,
incubating the microbial reagent in an incubating medium in the presence of at least one metal and under predetermined and controlled conditions to produce by a micobially-mediated reaction at least one extracellular metal containing product, and
recovering the product for subsequent use.

2. A process as set forth in claim 1 wherein the microorganism is selected from the group consisting of bacteria, fungi, algae, protozoa and spores, and mixtures thereof, capable of mediating extracellular product formation.

3. A process as set forth in claim 1 wherein the microbially-mediated reaction is selected from the group consisting of redox reactions, microbial processes that alter the extracellular environment, microbial excretion, microbial secretion, and mixtures thereof.

4. A process as set forth in claim 1 further including the step of pretreating the at least one microorganism prior to the incubating step.

5. A process as set forth in claim 1 wherein the incubating step is carried out in an incubating medium selected from the group consisting of a semi-solid medium, an aqueous medium, a nonaqueous liquid medium, a gaseous medium, and mixtures thereof.

6. A process as set forth in claim 1 wherein said metal is selected from the group consisting of metal oxides, metal hydroxides, metal oxyhydroxides, metal sulfides, metal phosphates, metal sulfates, metal carbonates, metal silicates, elemental metals, metalloids, and mixtures thereof.

7. A process as set forth in claim 1 wherein said extracellular product includes a metal selected from the group consisting of iron, manganese, magnesium, zinc, nickel, chromium, copper, silver, gold, lead, mercury, uranium, arsenic, selenium, cadmium, vanadium, radium, molybdenum, aluminum, fluorine, cobalt, iodine, barium, thorium, tin, antimony, technetium, ytterbium, tungsten, thallium, cerium, germanium, palladium, osmium, lanthanum, plutonium, strontium, titanium, rhodium, platinum, cesium, erbium, ruthenium, and mixtures thereof.

8. A process as set forth in claim 1 further including the step of further treating the extracellular metal containing product by at least one post-treatment step to alter the properties of said product.

9. A process as set forth in claim 1 wherein the microorganism present in said microbial reagent is selected from the group consisting of at least one actively growing microorganism, at least one resting microorganism, at least one nonviable organism, a preparation made from at least one microorganism, and combinations thereof.

10. A process as set forth in claim 1 wherein said incubating step is carried out at a temperature in the range of 3 degrees C. and 70 degrees C.

11. A process as set forth in claim 6 wherein said metal oxides, metal hydroxides, metal oxyhydroxides include iron.

12. A process as set forth in claim 6 wherein said metal oxides, metal hydroxides, metal oxyhydroxides contain manganese.

13. A process as set forth in claim 6 wherein said metal sulfide includes at least one sulfide containing iron.

14. A process as set forth in claim 1 wherein the microbial reagent includes at least one sulfate reducing microorganism.

15. A process as set forth in claim 1 wherein the microbial reagent includes at least one iron reducing microorganism.

16. A process as set forth in claim 1 wherein the microbial reagent includes at least one manganese oxidizing microorganism.

17. A process as set forth in claim 1 wherein said process is carried out on a batch basis.

18. A process as set forth in claim 1 wherein said process is carried out on a continuous basis.

19. A process as set forth in claim 1 wherein said process is carried out on a batch-continuous basis.

20. A process as set forth in claim 1 wherein said product is formed on the extracellular surface of the microbial reagent.

21. A process as set forth in claim 1 wherein said product is formed on one or more of the components of the microbial reagent.

22. A process as set forth in claim 1 wherein said product is a precipitate.

23. A process as set forth in claim 1 wherein said product is formed as a precipitate on the surface of the extracellular portion of said microorganism.

24. A process as set forth in claim 1 wherein said product is formed as a free precipitate in the incubation medium.

25. A process as set forth in claim 8 wherein said post-treatment includes the step of further incubation of said extracellular metal containing product in one or more media different from that of said incubating step.

26. A process as set forth in claim 8 wherein said post-treatment includes the step of further incubation with a microbial reagent different from said microbial reagent.

27. A process as set forth in claim 8 wherein said post-treatment includes the step selected from the group consisting of chemical extraction, biobleaching, drying, freeze drying, exposure to gases, exposure to chemicals, exposure to heat, exposure to pressure, exposure to irradiation, aging, separation from the microbial reagent, and combinations thereof.

28. A process as set forth in claim 1 wherein said predetermined and controlled conditions include controlling at least one of: the presence or concentration of inorganic ions, inorganic solids, salts, buffers, nutrients, substrates, dissolved gases; pH; complexing agents, chelating agents, inhibitors, stimulants, redox potentials; exposure to light, wavelengths and intensity of light; temperature; pressure; and length of time of the incubating step.

29. A process as set forth in claim 8 wherein the extracellular metal containing product is incubated in a solution containing a material selected from the group consisting of one or more metal ions, inorganic material containing metals, so that the metals are incorporated into the extracellular product.

30. A process as set forth in claim 4 wherein the step or pretreating includes at least one of the following steps: genetic engineering of key proteins or other cellular constituents, stressing or osmotic shock or pregrowth under predetermined conditions to cause overproduction or release of enzymes, induce formation of select biological molecules, alter the activity of biological molecules, influence metabolic pathways; chemical treatments to alter cell permeability, disrupt pH gradients, decompartmentalize cellular constituents; processing to cause elimination, removal, inhibition or substitution of one or more biological molecules or metabolic pathways involved with metal precipitation and/or biological molecules or pathways capable of influencing cellular metabolism, the internal chemical structure and/or extracellular environment; drying, heating, freezing, grinding, decompressing, treatment with ultrasonic sound; and combinations thereof.

31. A process for the reproducible preparation of inorganic nanophase materials, comprising the steps of:
preparing a microbial reagent which includes at least one microorganism selected from the group consisting of bacteria, fungi, algae, protozoa and spores, and mixtures thereof, capable of mediating extracellular product formation,
incubating the microbial reagent in an incubating medium selected from the group consisting of a semi-solid medium, an aqueous medium, a nonaqueous liquid medium, a gaseous medium, and mixtures thereof in the presence of at least one metal selected from the group consisting of metal oxides, metal hydroxides, metal oxyhydroxides, metal sulfides, metal phosphates, metal sulfates, metal carbonates, metal silicates, elemental metals, metalloids, and mixtures thereof to produce by a micobially-mediated reaction selected from the group consisting of redox reactions, microbial processes that alter the extracellular environment, microbial excretion, microbial secretion, and mixtures thereof at least one extracellular metal containing product,
said extracellular metal containing product including a metal selected from the group consisting of iron, manganese, magnesium, zinc, nickel, chromium, copper, silver, gold, lead, mercury, uranium, arsenic, selenium, cadmium, vanadium, radium, molybdenum, aluminum, fluorine, cobalt, iodine, barium, thorium, tin, antimony, technetium, ytterbium, tungsten, thallium, cerium, germanium, palladium, osmium, lanthanum, plutonium, strontium, titanium, rhodium, platinum, cesium, erbium, ruthenium, and mixtures thereof, and
recovering the product for subsequent use.
